(19) United States
(12) Patent Application Publication
(10) Pub. No.: US 2024/0209592 A1
(43) Pub. Date: Jun. 27, 2024

(54) Low-Thickness Rolling Guide Telescopic Rocker Arm

(71) Applicant: Suhua LIU, Shandong (CN)

(72) Inventor: Suhua LIU, Shandong (CN)

(21) Appl. No.: 18/288,386

(22) PCT Filed: Apr. 27, 2022
(86) PCT No.: PCT/CN2022/089646

§ 371 Date: Oct. 26, 2023

(30) Foreign Application Priority Data
Apr. 27, 2021 (CN) 202110462405.7
May 27, 2021 (CN) 202110585495.9

(51) Int. Cl. E02F 7/04

(52) U.S. Cl. CPC E02F 7/04

(57) ABSTRACT

Disclosed is a low-thickness rolling guide telescopic rocker arm, which includes a telescopic arm bracket, a rolling friction telescopic arm, an up/down-rolling support telescopic arm guide mechanism, and a left/right-righting telescopic arm guide mechanism. The up/down-rolling support telescopic arm guide mechanism includes an up/down support telescopic arm guide wheel or an up/down support telescopic arm guide piece. The up/down support telescopic arm guide wheel includes an up/down support guide axle and an up/down support sleeve wheel. The up/down support guide axle and the up/down support sleeve wheel are separately connected. The left/right-righting telescopic arm guide mechanism includes a left/right-righting telescopic arm guide wheel or a left/right-righting telescopic arm guide piece. The up/down support telescopic arm guide wheel is arranged on the telescopic arm bracket or the rolling friction telescopic arm.

### TECHNICAL FIELD

The disclosure belongs to the field of machinery, and in particular to a low-thickness rolling guide telescopic rocker arm.

### BACKGROUND

At present, rocker arms of excavators and loaders basically use sliding friction stretching and retraction and rolling friction stretching and retraction. The sliding friction stretching and retraction has high friction resistance and energy consumption. When impacted by external forces, a sliding friction slide is prone to deformation and locking, and unable to stretch and retract. The telescopic length of the rocker arm is usually 800 to 1500 mm, and after damage, a telescopic slide cannot be repaired in a roadway and must be pulled out of the roadway for repair. Due to the fact that the telescopic rocker arm is large in size and the weight is generally several tons or more, a significant waste of manpower and material resources, and time is caused, and due to the damage of the rocker arm, dozens of hours of downtime and production stoppage are caused, and a rolling friction telescopic rocker arm is used to avoid sliding friction faults. However, due to the fact that rollers are additionally arranged on the periphery of an inner telescopic oil cylinder and an outer cylinder of the existing rolling friction telescopic rocker arm, and the telescopic rocker arm needs the rollers with the strong support righting force to support several tons of a heading end and a raking and loading head, the volume of the rollers must be made as thick as a support shaft and an outer wheel skin. Upper rollers arranged on a telescopic arm obstruct the line of sight to observe the working status of the heading end and the raking and loading head, and lower rollers arranged on the lower part of the telescopic arm enable the rocker arm to reduce a channel for materials to enter a scraper conveyor at the lower part of the telescopic arm, which often leads to the inability of the materials to enter the scraper conveyor when the rocker arm falls, thereby hindering material transportation and reducing production efficiency. In order to solve the above problems, the disclosure proposes a low-thickness rolling guide telescopic rocker arm.

### SUMMARY

A low-thickness rolling guide telescopic rocker arm includes a telescopic arm bracket, a rolling friction telescopic arm, an up/down-rolling support telescopic arm guide mechanism, a left/right-righting telescopic arm guide mechanism, etc. The up/down-rolling support telescopic arm guide mechanism includes an up/down support telescopic arm guide wheel or an up/down support telescopic arm guide piece, etc. The up/down support telescopic arm guide wheel includes an up/down support guide axle and an up/down support sleeve wheel. The up/down support guide axle and the up/down support sleeve wheel are separately connected or integrated. The left/right-righting telescopic arm guide mechanism includes a left/right-righting telescopic arm guide wheel or a left/right-righting telescopic arm guide piece, etc. The up/down support telescopic arm guide wheel is arranged on the telescopic arm bracket or the rolling friction telescopic arm. The rolling friction telescopic arm includes a hollow I-shaped buckle wheel telescopic arm or a square buckle groove roller telescopic arm, etc. The hollow I-shaped buckle wheel telescopic arm includes a buckling guide wheel groove, etc. The buckling guide wheel groove includes a left buckling guide wheel groove and/or a right buckling guide wheel groove. The left buckling guide wheel groove includes an upper face of a left buckling support wheel, a lower face of the left buckling support wheel, and a left attaching left/right-righting face. The up/down support telescopic arm guide wheel rolls against the upper face of the left buckling support wheel or the lower face of the left buckling support wheel. The up/down support telescopic arm guide wheel is matched with the upper face of the left buckling support wheel and the lower face of the left buckling support wheel to guide the rolling friction telescopic arm, so as to prevent the rolling friction telescopic arm from shaking up and down during rolling friction stretching and retraction. The right buckling guide wheel groove includes an upper face of a right buckling support wheel, a lower face of the right buckling support wheel, and a right attaching left/right-righting face. The telescopic arm bracket includes a left/right support up/down guide wheel piece or an up/down support telescopic arm piece. The telescopic arm bracket further includes a telescopic arm bracket plate. The left/right support up/down guide wheel piece includes a left support up/down guide wheel piece and/or a right support up/down guide wheel piece, etc. The left support up/down guide wheel piece and/or the right support up/down guide wheel piece are/is arranged on the telescopic arm bracket plate. When the left/right support up/down guide wheel piece and the left/right-righting telescopic arm guide wheel are used, a support up/down guide axle or a support up/down guide wheel bracket is arranged on the left/right support up/down guide wheel piece, the up/down support telescopic arm guide wheel is arranged on the support up/down guide axle or the support up/down guide wheel bracket, a telescopic arm bracket support left/right-righting wheel bracket is arranged on the left/right support up/down guide wheel piece or an up/down guide wheel bracket support left/right-righting wheel bracket is arranged on the support up/down guide wheel bracket, and the left/right-righting telescopic arm guide wheel is arranged on the telescopic arm bracket support left/right-righting wheel bracket or the up/down guide wheel bracket support left/right-righting wheel bracket. The left buckling guide wheel groove and the right buckling guide wheel groove are arranged on both sides of the rolling friction telescopic arm. A front left up/down support telescopic arm guide wheel, a rear left up/down support telescopic arm guide wheel, a front right up/down support telescopic arm guide wheel, and a rear right up/down support telescopic arm guide wheel are arranged on the telescopic arm bracket. The front left up/down support telescopic arm guide wheel and the rear left up/down support telescopic arm guide wheel are arranged in the left buckling guide wheel groove and between the upper face of the left buckling support wheel and the lower face of the left buckling support wheel. The front right up/down support telescopic arm guide wheel and the rear right up/down support telescopic arm guide wheel are arranged in the right buckling guide wheel groove and between the upper face of the right buckling support wheel and the lower face of the right buckling support wheel. The left attaching left/right-righting face and the right attaching left/right-righting face form an attaching left/right-righting face. The left/right-righting telescopic arm guide wheel is arranged in the buckling guide wheel groove and a surface thereof is attached to the attaching left/right-righting face. The front left up/down support telescopic arm guide wheel and the rear left up/down support telescopic arm guide wheel support and guide the rolling friction telescopic arm through the upper face of the left buckling support wheel and the lower face of the left buckling support wheel, and the front right up/down support telescopic arm guide wheel and the rear right up/down support telescopic arm guide wheel support and guide the rolling friction telescopic arm through the upper face of the right buckling support wheel and the lower face of the right buckling support wheel, so as to prevent the rolling friction telescopic arm from shaking up and down. The telescopic arm bracket is provided with a left front left/right-righting telescopic arm guide wheel, a left rear left/right-righting telescopic arm guide wheel, a right front left/right-righting telescopic arm guide wheel, and a right rear left/right-righting telescopic arm guide wheel. The left front left/right-righting telescopic arm guide wheel, the left rear left/right-righting telescopic arm guide wheel, the right front left/right-righting telescopic arm guide wheel, and the right rear left/right-righting telescopic arm guide wheel guide the rolling friction telescopic arm through the attaching left/right-righting face, so as to prevent the rolling friction telescopic arm from shaking left and right.

The rolling friction telescopic arm includes the hollow I-shaped buckle wheel telescopic arm or the square buckle groove roller telescopic arm, etc. When the hollow I-shaped buckle wheel telescopic arm is used, the hollow I-shaped buckle wheel telescopic arm includes a hollow I-shaped frame. The left buckling guide wheel groove and the right buckling guide wheel groove are arranged on both sides of the hollow I-shaped buckle wheel telescopic arm. The hollow I-shaped frame includes an I-shaped hollow structure, etc. The rolling friction telescopic arm includes a telescopic oil cylinder, etc. A front end of the telescopic oil cylinder is connected to a front part of the I-shaped hollow structure, and a rear end of the telescopic oil cylinder is connected to the telescopic arm bracket. The telescopic oil cylinder stretches and retracts to drive the rolling friction telescopic arm to stretch and retract. Or when the square buckle groove roller telescopic arm is used, the square buckle groove roller telescopic arm includes a square telescopic frame, a flank roller mechanism, etc. The flank roller mechanism is arranged on both sides of the square telescopic frame. The flank roller mechanism includes an up/down support telescopic arm roller and a left/right-righting telescopic arm roller or includes the up/down support telescopic arm roller, a left/right-righting telescopic arm guide plate, etc. The up/down support telescopic arm roller and the left/right-righting telescopic arm roller form an up/down left/right guide wheel set. The up/down left/right guide wheel set includes a left front up/down left/right guide wheel set, a left rear up/down left/right guide wheel set, a right front up/down left/right guide wheel set, and a right rear up/down left/right guide wheel set. The left front up/down left/right guide wheel set and the left rear up/down left/right guide wheel set are sequentially arranged on a left side of the square telescopic frame, and the right front up/down left/right guide wheel set and the right rear up/down left/right guide wheel set are sequentially arranged on a right side of the square telescopic frame. The telescopic arm bracket includes a bracket left buckle wheel groove, a bracket right buckle wheel groove, etc. The bracket left buckle wheel groove includes an upper plate of the bracket left buckle wheel groove, a lower plate of the bracket left buckle wheel groove, etc. The bracket right buckle wheel groove includes an upper plate of the bracket right buckle wheel groove, a lower plate of the bracket right buckle wheel groove, etc. The upper plate of the bracket left buckle wheel groove and the upper plate of the bracket right buckle wheel groove are separated or integrated, and the lower plate of the bracket left buckle wheel groove and the lower plate of the bracket right buckle wheel groove are separated or integrated. The left front up/down left/right guide wheel set and the left rear up/down left/right guide wheel set are arranged in the bracket left buckle wheel groove, and the right front up/down left/right guide wheel set and the right rear up/down left/right guide wheel set are arranged in the bracket right buckle wheel groove. The left front up/down left/right guide wheel set, the left rear up/down left/right guide wheel set, the right front up/down left/right guide wheel set, and the right rear up/down left/right guide wheel set support the square telescopic frame. One end of the telescopic oil cylinder is connected to a front part of the square telescopic frame, while the other end thereof is connected to the telescopic arm bracket. The telescopic oil cylinder stretches and retracts to drive the square buckle groove roller telescopic arm to stretch and retract.

The telescopic arm bracket includes a wheel groove frame, etc. The wheel groove frame includes a left wheel groove frame and/or a right wheel groove frame, etc. The telescopic arm bracket further includes a left support wheel groove frame piece and/or a right support wheel groove frame piece, etc. The left wheel groove frame is arranged on the left support wheel groove frame piece, and the right wheel groove frame is arranged on the right support wheel groove frame piece. The telescopic arm bracket includes a holding wheel groove frame plate. The wheel groove frame is arranged on the side of the holding wheel groove frame plate. A gap for placing the left buckling guide wheel groove and the right buckling guide wheel groove is arranged between the wheel groove frame and the holding wheel groove frame plate. A front support guide wheel groove frame hole and/or a rear support guide wheel groove frame hole are/is arranged on the left wheel groove frame. A front left support guide axle hole and/or a rear left support guide axle hole are/is correspondingly arranged in the left support wheel groove frame piece. The up/down support telescopic arm guide wheel is arranged in the front support guide wheel groove frame hole, and supported by the front left support guide axle hole and/or the rear left support guide axle hole. The surface of the up/down support telescopic arm guide wheel is higher than the surface of the wheel groove frame. The upper and lower surfaces of the up/down support telescopic arm guide wheel are respectively matched with the upper face of the left buckling support wheel and the lower face of the left buckling support wheel in parallel, the lower face of the left buckling support wheel and the lower face of the right buckling support wheel support the rolling friction telescopic arm, and the upper face of the left buckling support wheel and the upper face of the right buckling support wheel limit the rolling friction telescopic arm to tilt up.

The left/right-righting telescopic arm guide wheel includes a left/right-righting telescopic arm shaft, a left/right-righting telescopic arm wheel, etc. The left/right-righting telescopic arm shaft penetrates through the left/right-righting telescopic arm wheel to guide the rolling friction of the rolling friction telescopic arm left and right. A support left-right guide axle piece is arranged on an end face of a support up/down guide wheel bracket towards the attaching left/right-righting face of the rolling friction telescopic arm. The support left-right guide axle piece includes an upper support left-right guide axle piece and a lower support left-right guide axle piece, which support the left/right-righting telescopic arm shaft. The left/right-righting telescopic arm shaft penetrates through the left/right-righting telescopic arm wheel to guide the rolling friction of the telescopic arm left and right. Or when the left/right-righting telescopic arm shaft and the left/right-righting telescopic arm wheel are integrated, the left/right-righting telescopic arm shaft and the left/right-righting telescopic arm wheel form a left/right-righting telescopic arm shaft wheel. The upper support left-right guide axle piece and the lower support left-right guide axle piece support the left/right-righting telescopic arm shaft wheel. The attaching left/right-righting face protrudes from the bottom of the left buckling guide wheel groove and the right buckling guide wheel groove to the side of the left/right-righting telescopic arm shaft wheel. The protruding length of the attaching left/right-righting face makes the left/right-righting telescopic arm shaft wheel abut against the attaching left/right-righting face. The left/right-righting telescopic arm shaft wheel rotates to guide the rolling friction of the rolling friction telescopic arm left and right. The left/right-righting telescopic arm guide piece includes a flat plate left/right-righting telescopic arm piece or an arc plate left/right-righting telescopic arm piece or a ball plate left/right-righting telescopic arm piece or a hole plate left/right-righting telescopic arm piece or a groove plate left/right-righting telescopic arm piece or a roller plate left/right-righting telescopic arm piece. When the roller plate left/right-righting telescopic arm piece is used, the roller plate left/right-righting telescopic arm piece includes an embedded roller hole plate and a roller. The width of a roller hole exposed on the embedded roller hole plate is less than the diameter of the roller. The embedded roller hole plate is fixed to the wheel groove frame, the roller is arranged on the embedded roller hole plate, a cylinder part thereof exposes the embedded roller hole plate, and a roller surface is attached to the left attaching left/right-righting face and/or the right attaching left/right-righting face, so as to right the rolling friction telescopic arm left and right.

A front end of the rolling friction telescopic arm is provided with an excavation head or a material raking head or an impact head, etc. When the rolling friction telescopic arm stretches and retracts forwards, a wheel face of the front left up/down support telescopic arm guide wheel is attached to the upper face of the left buckling support wheel, a wheel face of the rear left up/down support telescopic arm guide wheel is attached to the lower face of the left buckling support wheel, a wheel face of the front right up/down support telescopic arm guide wheel is attached to the upper face of the right buckling support wheel, and a wheel face of the right rear up/down support telescopic arm guide wheel is attached to the lower face of the right buckling support wheel. The left/right-righting telescopic arm guide wheel includes the left front left/right-righting telescopic arm guide wheel, the right front left/right-righting telescopic arm guide wheel, the left rear left/right-righting telescopic arm guide wheel, and the right rear left/right-righting telescopic arm guide wheel. The wheel faces of the left front left/right-righting telescopic arm guide wheel and the left rear left/right-righting telescopic arm guide wheel are attached to the left attaching left/right-righting face, and the wheel faces of the right front left/right-righting telescopic arm guide wheel and the right rear left/right-righting telescopic arm guide wheel are attached to the right attaching left/right-righting face. The left front left/right-righting telescopic arm guide wheel, the right front left/right-righting telescopic arm guide wheel, the left rear left/right-righting telescopic arm guide wheel, and the right rear left/right-righting telescopic arm guide wheel are attached to the left/right-righting faces to prevent the rolling friction telescopic arm from shaking left and right. A distance between the upper face of the left buckling support wheel and the lower face of the left buckling support wheel is greater than or equal to the diameter of the up/down support telescopic arm guide wheel, and the spacing range is no more than 10 mm, so that the excavation head or the material raking head or the impact head, etc., is stably supported.

A front part of the rolling friction telescopic arm is provided with a material raking and loading part. The material raking and loading part further includes a rotating raking and loading machine or a telescopic raking and loading machine, etc. The rolling friction telescopic arm includes a rotating rolling friction telescopic arm or a fixed rolling friction telescopic arm or a hinged shaft rolling friction telescopic arm. A rear end of the rotating rolling friction telescopic arm is provided with a rotating telescopic arm structure, and the rotating telescopic arm structure drives the rotating rolling friction telescopic arm to rotate left and right. A rear end of the hinged shaft rolling friction telescopic arm is provided with a telescopic arm hinged shaft, the telescopic arm hinged shaft supports the hinged shaft rolling friction telescopic arm to swing up and down, the hinged shaft rolling friction telescopic arm is driven by a lifting power to swing up and down, or the hinged shaft rolling friction telescopic arm swings upwards when the material raking and loading part ascends with materials and rakes the materials upwards, and swings downwards when the material raking and loading part descends with the materials and rakes the materials downwards. The weight of the hinged shaft rolling friction telescopic arm is the material raking gravity.

The front part of the rolling friction telescopic arm is provided with a support rotating swing arm structure, a rotating swing arm, a rotating raking and loading part, etc. The rotating raking and loading part is arranged at a front end of the rotating swing arm. The support rotating swing arm structure includes a support rotating arm swing shaft and a rotating swing arm driving piece. The rotating swing arm includes a rotating swing arm sleeve and a rotating arm connecting drive device. The support rotating arm swing shaft is supported by the rolling friction telescopic arm or a sliding friction telescopic arm, and the support rotating arm swing shaft penetrates through the rotating swing arm sleeve. The rotating arm connecting drive device is arranged on a left side and/or a right side of the rotating swing arm sleeve. One end of the rotating swing arm driving piece is fixed to the rolling friction telescopic arm or the sliding friction telescopic arm, while the other end thereof is hinged with the rotating arm connecting drive device. The rotating swing arm driving piece drives the rotating arm connecting drive device, the rotating arm connecting drive device drives the rotating swing arm sleeve to rotate, and the rotating swing arm swings left and right to drive the rotating raking and loading part to swing left and right and rake the materials. Lower parts of the rolling friction telescopic arm and the rotating swing arm are provided with a material receiving, transporting and discharging part. The material receiving, transporting and discharging part includes a material receiving, transporting and discharging shovel plate. The material receiving, transporting and discharging shovel plate includes a fan-shaped material receiving, transporting and discharging shovel plate or a square material receiving, transporting and discharging shovel plate or a polygonal material receiving, transporting and discharging shovel plate. The length of the rotating swing arm and the shape of the rotating raking and loading part are arranged according to the height, width and shape of the material receiving, transporting and discharging part, so that the rotating radius of the rotating raking and loading part is matched with the structure of the material receiving, transporting and discharging shovel plate to rake the materials at the periphery of the material receiving, transporting and discharging shovel plate into the material receiving, transporting and discharging part.

The rotating swing arm includes a transmission power piece or a transmission channel, etc. The transmission channel is arranged in the middle of the rotating swing arm or the upper part of the rotating swing arm. The rotating raking and loading part includes a raking and loading head power piece and/or a raking and loading head transmission piece, etc. When the raking and loading head power piece is used, the raking and loading head power piece includes a transmission hose or a transmission cable, etc. The rotating raking and loading machine is provided with a rotating material raking head, a fixed raking and loading head power piece structure, etc. The transmission hose or the transmission cable passes through the transmission channel and is connected to the raking and loading head transmission piece or the transmission hose or the transmission cable is arranged at the upper part of the rotating swing arm and connected to the raking and loading head transmission piece. The raking and loading head power piece is arranged on the fixed raking and loading head power piece structure, the rotating material raking head is arranged on one side or both sides of the raking and loading head power piece, and the raking and loading head power piece rotates to drive the rotating material raking head to rotate and rake and load the material continuously. When the transmission power piece is used, the rotating raking and loading machine includes a raking and loading head transmission piece. The raking and loading head transmission piece includes a gear transmission piece or a chain gear transmission piece, etc. The gear transmission piece includes a raking and loading head gear transmission piece, a swing arm gear transmission piece, etc. The swing arm gear transmission piece is arranged on the rotating swing arm or the rolling friction telescopic arm, the swing arm gear transmission piece drives the raking and loading head gear transmission piece, the raking and loading head gear transmission piece drives the rotating material raking head, the swing arm gear transmission piece drives the raking and loading head gear transmission piece, and the raking and loading head gear transmission piece drives the rotating raking and loading machine, so that the materials are continuously raked and loaded in a rolling manner.

The left/right-righting telescopic arm guide wheel includes a left/right-righting telescopic arm guide roller, etc. When the left/right support up/down guide wheel piece and the left/right-righting telescopic arm guide roller are used, a support left/right-righting roller bracket is arranged on the left/right support up/down guide wheel piece or the telescopic arm bracket plate. The left/right-righting telescopic arm guide roller is arranged on the support left/right-righting roller bracket. The support left/right-righting roller bracket includes a roller arc groove. The left/right-righting telescopic arm guide roller is arranged in the roller arc groove, so that part of roller body of the left/right-righting telescopic arm guide roller towards a direction of the attaching left/right-righting face protrudes from a notch of the roller arc groove, the protruding part is attached to the attaching left/right-righting face, and the left/right-righting telescopic arm guide roller rights the reciprocating stretching and retraction of the rolling friction telescopic arm, thereby reducing the left-right thickness of the low-thickness rolling guide telescopic rocker arm.

The telescopic arm bracket further includes a support telescopic arm guide wheel plate or a holding telescopic arm guide wheel groove frame or a holding telescopic arm guide wheel groove block, etc. The up/down support telescopic arm guide wheel includes an up/down support telescopic arm guide roller or an up/down support telescopic arm guide wheel, etc. The left/right-righting telescopic arm guide wheel includes a left/right-righting telescopic arm guide roller or a left/right-righting telescopic arm guide shaft wheel, etc. When the holding telescopic arm guide wheel groove frame is used, the holding telescopic arm guide wheel groove frame includes an upper support plate of the guide wheel groove frame, a lower support plate of the guide wheel groove frame, an upper and lower support plate connecting piece, etc. The upper and lower support plate connecting piece is connected to the upper support plate of the guide wheel groove frame and the lower support plate of the guide wheel groove frame, so as to form a support guide wheel frame structure. The up/down support telescopic arm guide wheel and the left/right-righting telescopic arm guide wheel are tightly combined in the support guide wheel frame structure, or when the holding telescopic arm guide wheel groove block is used, the holding telescopic arm guide wheel groove block includes a holding up/down guide wheel arc groove and/or a support left-right guide wheel arc groove, etc. The up/down support telescopic arm guide roller is arranged in the holding up/down guide wheel arc groove and/or the left/right-righting telescopic arm guide roller is arranged in the support left-right guide wheel arc groove.

The disclosure has the following beneficial effects.

1. The up/down support telescopic arm guide wheel is arranged on the telescopic arm bracket or the rolling friction telescopic arm, and the left support up/down guide wheel piece and/or the right support up/down guide wheel piece are/is arranged on the telescopic arm bracket plate. When the left/right support up/down guide wheel piece and the left/right-righting telescopic arm guide wheel are used, the support up/down guide axle or the support up/down guide wheel bracket is arranged on the left/right support up/down guide wheel piece, the up/down support telescopic arm guide wheel is arranged on the support up/down guide axle or the support up/down guide wheel bracket, the telescopic arm bracket support left/right-righting wheel bracket is arranged on the left/right support up/down guide wheel piece or the up/down guide wheel bracket support left/right-righting wheel bracket is arranged on the support up/down guide wheel bracket, and the left/right-righting telescopic arm guide wheel is arranged on the telescopic arm bracket support left/right-righting wheel bracket or the up/down guide wheel bracket support left/right-righting wheel bracket. The left buckling guide wheel groove and the right buckling guide wheel groove are arranged on both sides of the rolling friction telescopic arm. The front left up/down support telescopic arm guide wheel, the rear left up/down support telescopic arm guide wheel, the front right up/down support telescopic arm guide wheel, and the rear right up/down support telescopic arm guide wheel are arranged on the telescopic arm bracket. The front left up/down support telescopic arm guide wheel and the rear left up/down support telescopic arm guide wheel are arranged in the left buckling guide wheel groove and between the upper face of the left buckling support wheel and the lower face of the left buckling support wheel. The front right up/down support telescopic arm guide wheel and the rear right up/down support telescopic arm guide wheel are arranged in the right buckling guide wheel groove and between the upper face of the right buckling support wheel and the lower face of the right buckling support wheel. The left/right-righting telescopic arm guide wheel is arranged in the buckling guide wheel groove and the surface thereof is attached to the attaching left/right-righting face. The front left up/down support telescopic arm guide wheel and the rear left up/down support telescopic arm guide wheel support and guide the rolling friction telescopic arm through the upper face of the left buckling support wheel and the lower face of the left buckling support wheel, and the front right up/down support telescopic arm guide wheel and the rear right up/down support telescopic arm guide wheel support and guide the rolling friction telescopic arm through the upper face of the right buckling support wheel and the lower face of the right buckling support wheel, so as to prevent the rolling friction telescopic arm from shaking up and down. The telescopic arm bracket is provided with the left front left/right-righting telescopic arm guide wheel, the left rear left/right-righting telescopic arm guide wheel, the right front left/right-righting telescopic arm guide wheel, and the right rear left/right-righting telescopic arm guide wheel. The left front left/right-righting telescopic arm guide wheel, the left rear left/right-righting telescopic arm guide wheel, the right front left/right-righting telescopic arm guide wheel, and the right rear left/right-righting telescopic arm guide wheel guide the rolling friction telescopic arm through the attaching left/right-righting face, so as to prevent the rolling friction telescopic arm from shaking left and right. The up/down-rolling support telescopic arm guide mechanism and the left/right-righting telescopic arm guide mechanism are arranged on both sides between the rolling friction telescopic arm and the telescopic arm bracket. The rollers arranged in four directions of the rolling friction telescopic arm are changed to be arranged on both sides of the rolling friction telescopic arm for performing rolling support, guiding and righting on the rolling friction telescopic arm, so that the rolling friction telescopic arm neither jumps up and down nor shakes left and right, and the up/down thickness of the rolling friction telescopic arm is greatly reduced or the left-right thickness of the rolling friction telescopic arm is reduced, sliding friction faults are avoided, the defect that large-size roller structures additionally arranged on the periphery of an inner telescopic cylinder and an outer cylinder of the currently used rolling friction telescopic rocker arm obstruct the line of sight to observe the working status of a heading end and a raking and loading head, so that the rocker arm reduces a channel for the materials to enter a scraper conveyor at the lower part of the telescopic arm is also avoided, the bad structure that makes the materials unable to enter the scraper conveyor when the rolling friction telescopic arm falls to hinder material transportation is changed, the production efficiency is improved, and the strength of the telescopic rocker arm to support several tons of parts of the heading end and the raking and loading head is ensured. The disclosure has compact structure and reduces the use of raw materials. The left/right support up/down guide wheel piece is matched with the up/down support telescopic arm guide wheel, and the left/right-righting telescopic arm guide wheel guides the rolling friction telescopic arm through the attaching left/right-righting face, so that the use structural strength is high, the righting force is large, the installation and maintenance are simple and quick, and the working efficiency and flexibility of the rocker arm adapting to mining various materials are improved.

2. When the left/right support up/down guide wheel piece and the left/right-righting telescopic arm guide piece are used, the support up/down guide axle or the support up/down guide wheel bracket is arranged on the left/right support up/down guide wheel piece, the up/down support telescopic arm guide wheel is arranged on the support up/down guide axle or the support up/down guide wheel bracket, the left/right-righting telescopic arm guide piece is arranged on the end of the support up/down guide axle or the support up/down guide wheel bracket, and the left/right-righting telescopic arm guide piece and the support up/down guide wheel bracket are separately connected or integrated. The buckling guide wheel groove is arranged on both sides of the rolling friction telescopic arm. The up/down support telescopic arm guide wheel is arranged in the buckling guide wheel groove and between the upper face of the buckling support wheel and the lower face of the buckling support wheel. The left/right-righting telescopic arm guide piece is arranged in the buckling guide wheel groove and the surface thereof is attached to the attaching left/right-righting face. The front left up/down support telescopic arm guide wheel, the rear left up/down support telescopic arm guide wheel, the front right up/down support telescopic arm guide wheel, and the rear right up/down support telescopic arm guide wheel are arranged on the telescopic arm bracket. The front left up/down support telescopic arm guide wheel, the rear left up/down support telescopic arm guide wheel, the front right up/down support telescopic arm guide wheel, and the rear right up/down support telescopic arm guide wheel support and guide the rolling friction telescopic arm through the upper face of the buckling support wheel and the lower face of the buckling support wheel, so as to prevent the rolling friction telescopic arm from shaking left and right. Orientation-fit attaching left/right-righting face guide wear-resistant parts are arranged on a front left left/right-righting telescopic arm guide piece, a rear left left/right-righting telescopic arm guide piece, a rear left left/right-righting telescopic arm guide piece, and a rear right left/right-righting telescopic arm guide piece. The front left left/right-righting telescopic arm guide piece, the rear left left/right-righting telescopic arm guide piece, the rear left left/right-righting telescopic arm guide piece, and the rear right left/right-righting telescopic arm guide piece guide the rolling friction telescopic arm through the attaching left/right-righting face, so as to prevent the rolling friction telescopic arm from shaking left and right. The left/right-righting telescopic arm guide wheel is replaced by the attaching left/right-righting face guide wear-resistant parts, so that the depth of the buckling guide wheel groove is reduced, the width of the face of the buckling support wheel is reduced, the left-right width of the rolling friction telescopic rocker arm is reduced, the manufacturing cost is saved, and the strength of the face of the buckling support wheel is relatively improved. The attaching left/right-righting face guide wear-resistant parts are matched with the up/down support telescopic arm guide wheel, and the up/down support telescopic arm guide wheel supports the rolling friction of the rolling friction telescopic arm, so that the friction resistance of the telescopic arm to the up/down support piece under the action of the gravity of the earth is reduced, and at the same time, the attaching left/right-righting face guide wear-resistant parts are used to right the telescopic arm left and right, the parts with large friction resistance are supported through rolling friction, and the parts with relatively small friction resistance are righted through sliding friction. The structure is ingenious, simple and reliable, the manufacturing cost is low, and the installation and maintenance are simple and quick.

3. The left/right-righting telescopic arm shaft penetrates through the left/right-righting telescopic arm wheel to guide the rolling friction of the telescopic arm left and right. The support left-right guide axle piece is arranged on the end face of the support up/down guide wheel bracket towards the attaching left/right-righting face of the telescopic arm. The upper support left-right guide axle piece and the lower support left-right guide axle piece support the left/right-righting telescopic arm shaft. The left/right-righting telescopic arm shaft penetrates through the left/right-righting telescopic arm wheel to guide the rolling friction of the telescopic arm left and right. Or when the left/right-righting telescopic arm shaft and the left/right-righting telescopic arm wheel are integrated, the left/right-righting telescopic arm shaft and the left/right-righting telescopic arm wheel form the left/right-righting telescopic arm shaft wheel. The upper support left-right guide axle piece and the lower support left-right guide axle piece support the left-right support telescopic arm shaft wheel. The attaching left/right-righting face protrudes from the bottom of the left buckling guide wheel groove and the right buckling guide wheel groove to the side of the left/right-righting telescopic arm shaft wheel. The protruding length of the attaching left/right-righting face makes the left/right-righting telescopic arm shaft wheel abut against the attaching left/right-righting face. The left/right-righting telescopic arm shaft wheel rotates to guide the rolling friction of the telescopic arm left and right. The left/right-righting telescopic arm shaft wheel is used, that is, the roller shaft is used as the roller, so that the diameter of the roller is reduced, the depth of the buckling guide wheel groove is reduced, the left-right width of the rolling friction telescopic rocker arm is reduced, the weight of the rolling friction telescopic rocker arm is reduced, and the left/right-righting of the rolling friction of the telescopic arm is cleverly realized.

4. When the hollow I-shaped buckle wheel telescopic arm is used, the left buckling guide wheel groove and the right buckling guide wheel groove are arranged on both sides of the hollow I-shaped buckle wheel telescopic arm, the front end of the telescopic oil cylinder is connected to the front part of the I-shaped hollow structure, the rear end of the telescopic oil cylinder is connected to the telescopic arm bracket, and the telescopic oil cylinder stretches and retracts to drive the rolling friction telescopic arm to stretch and retract. Or when the square buckle groove roller telescopic arm is used, the flank roller mechanism is arranged on both sides of the square telescopic frame. The up/down support telescopic arm roller and the left/right-righting telescopic arm roller form the up/down left/right guide wheel set. The left front up/down left/right guide wheel set and the left rear up/down left/right guide wheel set are sequentially arranged on the left side of the square telescopic frame, and the right front up/down left/right guide wheel set and the right rear up/down left/right guide wheel set are sequentially arranged on the right side of the square telescopic frame. The left front up/down left/right guide wheel set and the left rear up/down left/right guide wheel set are arranged in the bracket left buckle wheel groove, and the right front up/down left/right guide wheel set and the right rear up/down left/right guide wheel set are arranged in the bracket right buckle wheel groove. The left front up/down left/right guide wheel set, the left rear up/down left/right guide wheel set, the right front up/down left/right guide wheel set, and the right rear up/down left/right guide wheel set support the square telescopic frame. One end of the telescopic oil cylinder is connected to the front part of the square telescopic frame, while the other end thereof is connected to the telescopic arm bracket. The telescopic oil cylinder stretches and retracts to drive the square buckle groove roller telescopic arm to stretch and retract. The upper plate of the bracket left buckle wheel groove and the upper plate of the bracket right buckle wheel groove are integrated, and the lower plate of the bracket left buckle wheel groove and the lower plate of the bracket right buckle wheel groove are integrated, so that the overall height of the rolling friction telescopic arm is reduced, the structural strength is large, the structure is compact, and the occupied space is small. The flank roller mechanism is arranged on the square buckle groove roller telescopic arm, which is conducive to taking out the square buckle groove roller telescopic arm when maintenance is required, so that open maintenance may be performed on the up/down left/right guide wheel set on the square buckle groove roller telescopic arm, and the maintenance efficiency is improved. A hollow part of the hollow I-shaped buckle wheel telescopic arm is provided with the telescopic oil cylinder, so that the complex structure of arranging the telescopic oil cylinders on both sides is avoided, the telescopic errors of the two oil cylinders are avoided by stretching and retracting one oil cylinder, the telescopic accuracy is improved, the structure is simple and reliable, and the manufacturing cost is saved.

5. The left wheel groove frame is arranged on the left support wheel groove frame piece, and the right wheel groove frame is arranged on the right support wheel groove frame piece. The wheel groove frame is arranged on the side of the holding wheel groove frame plate. The gap for placing the left buckling guide wheel groove and the right buckling guide wheel groove is arranged between the wheel groove frame and the holding wheel groove frame plate. The front support guide wheel groove frame hole and/or the rear support guide wheel groove frame hole are/is arranged on the left wheel groove frame. The front left support guide axle hole and/or the rear left support guide axle hole are/is correspondingly arranged in the left support wheel groove frame piece. The up/down support telescopic arm guide wheel is arranged in the front support guide wheel groove frame hole, and supported by the front left support guide axle hole and/or the rear left support guide axle hole. The surface of the up/down support telescopic arm guide wheel is higher than the surface of the wheel groove frame. The upper and lower surfaces of the up/down support telescopic arm guide wheel are respectively matched with the upper face of the left buckling support wheel and the lower face of the left buckling support wheel in parallel, the lower face of the left buckling support wheel and the lower face of the right buckling support wheel support the rolling friction telescopic arm, and the upper face of the left buckling support wheel and the upper face of the right buckling support wheel limit the rolling friction telescopic arm to tilt up. Although the wheel groove frame is suspended on the side of the telescopic arm bracket, the front support guide wheel groove frame hole is matched with the front left support guide axle hole to support the up/down support telescopic arm guide axle, so that the support strength of the up/down support telescopic arm guide wheel is improved by the support through two shaft holes, which is convenient for machining, manufacturing, installation and maintenance. The support up/down guide wheel brackets which are sequentially arranged are connected into a frame structure through the wheel groove frame, so that the structural strength of the support up/down guide wheel bracket is improved, and the stability of the up/down support telescopic arm guide wheel is improved. Because the wheel groove frame and the telescopic arm bracket are connected in a long-distance frame-shaped multi-point manner, the structural strength of the support up/down guide wheel bracket is greatly increased, and the service life of the rolling guide mechanism is prolonged.

6. When the roller plate left/right-righting telescopic arm piece is used, the width of the roller hole exposed on the embedded roller hole plate is less than the diameter of the roller, the embedded roller hole plate is fixed to the wheel groove frame, the roller is arranged on the embedded roller hole plate, the cylinder part thereof exposes the embedded roller hole plate, and the roller surface is attached to the left attaching left/right-righting face and/or the right attaching left/right-righting face, so as to right the rolling friction telescopic arm left and right, thereby reducing the width of a righting mechanism for righting the rolling friction telescopic arm left and right, correspondingly reducing the width of the rolling friction telescopic arm, saving the manufacturing cost and the device installation space, and prolonging the service life of the rocker arm.

7. When the rolling friction telescopic arm stretches and retracts forwards, the wheel face of the front left up/down support telescopic arm guide wheel is attached to the upper face of the left buckling support wheel, the wheel face of the rear left up/down support telescopic arm guide wheel is attached to the lower face of the left buckling support wheel, the wheel face of the front right up/down support telescopic arm guide wheel is attached to the upper face of the right buckling support wheel, and the wheel face of the right rear up/down support telescopic arm guide wheel is attached to the lower face of the right buckling support wheel. The wheel faces of the left front left/right-righting telescopic arm guide wheel and the left rear left/right-righting telescopic arm guide wheel are attached to the left attaching left/right-righting face, and the wheel faces of the right front left/right-righting telescopic arm guide wheel and the right rear left/right-righting telescopic arm guide wheel are attached to the right attaching left/right-righting face. The left front left/right-righting telescopic arm guide wheel, the right front left/right-righting telescopic arm guide wheel, the left rear left/right-righting telescopic arm guide wheel, and the right rear left/right-righting telescopic arm guide wheel are attached to the left/right-righting faces to prevent the rolling friction telescopic arm from shaking left and right. A distance between the upper face of the left buckling support wheel and the lower face of the left buckling support wheel is greater than or equal to the diameter of the up/down support telescopic arm guide wheel, and the spacing range is no more than 10 mm, so that the excavation head or the material raking head or the impact head, etc., is stably supported, an impact part is effectively buffered, and the stable operation of the device is ensured.

8. The rear end of the rotating rolling friction telescopic arm is provided with the rotating telescopic arm structure, and the rotating telescopic arm structure drives the rotating rolling friction telescopic arm to rotate left and right. The rear end of the hinged shaft rolling friction telescopic arm is provided with the telescopic arm hinged shaft, the telescopic arm hinged shaft supports the hinged shaft rolling friction telescopic arm to swing up and down, the hinged shaft rolling friction telescopic arm is driven by the lifting power to swing up and down, or the hinged shaft rolling friction telescopic arm swings upwards when the material raking and loading part ascends with materials and rakes the materials upwards, and swings downwards when the material raking and loading part descends with the materials and rakes the materials downwards. The weight of the hinged shaft rolling friction telescopic arm is the material raking gravity. The rotating material raking head rotationally rakes the materials, and raking and loading teeth rake the materials, and ascend and descend with the height of the materials for raking and loading the materials. Through material raking and crawling functions of the raking and loading teeth, the raking and loading head and the telescopic arm ascend and descend with the height of the materials, and the materials are raked into a scraper through the weight of the raking and loading head and the telescopic arm, so that the hard damage to the raking and loading part and the rolling friction telescopic arm due to excessive power drive is avoided.

9. The rotating raking and loading part is arranged at the front end of the rotating swing arm, the support rotating arm swing shaft is supported by the rolling friction telescopic arm support or the sliding friction telescopic arm, the support rotating arm swing shaft penetrates through the rotating swing arm sleeve, the rotating arm connecting drive device is arranged on the left side and/or the right side of the rotating swing arm sleeve, one end of the rotating swing arm driving piece is fixed to the rolling friction telescopic arm or the sliding friction telescopic arm, while the other end thereof is hinged with the rotating arm connecting drive device, the rotating swing arm driving piece drives the rotating arm connecting drive device, the rotating arm connecting drive device drives the rotating swing arm sleeve to rotate, and the rotating swing arm swings left and right to drive the rotating raking and loading part to swing left and right and rake the materials. In the disclosure, the hinged shaft rolling friction telescopic arm is matched with the rotating swing arm to rake the materials in a telescopic manner, the lower parts of the rolling friction telescopic arm and the rotating swing arm are provided with the material receiving, transporting and discharging part, and the length of the rotating swing arm and the shape of the rotating raking and loading part are arranged according to the height, width and shape of the material receiving, transporting and discharging part, so that the rotating radius of the rotating raking and loading part is matched with the structure of the material receiving, transporting and discharging shovel plate to rake the materials at the periphery of the material receiving, transporting and discharging shovel plate into the material receiving, transporting and discharging part, thereby avoiding the problems that the rotating radius of the rotating raking and loading part driven by the rolling friction telescopic arm is greater than the radius of the fan-shaped material receiving, transporting and discharging shovel plate due to the rotation of the rolling friction telescopic arm, so that the materials on both sides of the fan-shaped material receiving, transporting and discharging shovel plate cannot be raked into the material receiving, transporting and discharging part, etc. The structure is ingenious and the practicability is strong.

10. The rotating swing arm includes the transmission power piece or the transmission channel. The transmission channel is arranged in the middle of the rotating swing arm or the upper part of the rotating swing arm. The rotating raking and loading part includes the raking and loading head power piece and/or the raking and loading head transmission piece. When the raking and loading head power piece is used, the raking and loading head power piece includes the transmission hose or the transmission cable. The rotating raking and loading machine is provided with the rotating material raking head and the fixed raking and loading head power piece structure. The transmission hose or the transmission cable passes through the transmission channel and is connected to the raking and loading head transmission piece or the transmission hose or the transmission cable is arranged at the upper part of the rotating swing arm and connected to the raking and loading head transmission piece. The raking and loading head power piece is arranged on the fixed raking and loading head power piece structure, the rotating material raking head is arranged on one side or both sides of the raking and loading head power piece, and the raking and loading head power piece rotates to drive the rotating material raking head to rotate and rake and load the material continuously. When the transmission power piece is used, the rotating raking and loading machine includes the raking and loading head transmission piece. The raking and loading head transmission piece includes the gear transmission piece or the chain gear transmission piece. The gear transmission piece includes the raking and loading head gear transmission piece and the swing arm gear transmission piece. The swing arm gear transmission piece is arranged on the rotating swing arm or the rolling friction telescopic arm, the swing arm gear transmission piece drives the raking and loading head gear transmission piece, the raking and loading head gear transmission piece drives the rotating material raking head, the swing arm gear transmission piece drives the raking and loading head gear transmission piece, and the raking and loading head gear transmission piece drives the rotating raking and loading machine, so that the materials are continuously raked and loaded in a rolling manner. The raking and loading head power piece is arranged at the front part of the rotating swing arm, the raking and loading head power piece directly drives the rotating raking and loading head to rake the materials, so that the rotating raking and loading head is accurate in positioning, high in material raking precision, and high in kinetic energy utilization rate. The raking and loading gear transmission piece drives the rotating material raking head, so that the raking and loading head power piece is rear positioned to avoid the material bump and damage to the raking and loading head power piece, and effectively protect a power mechanism. The raking and loading head power piece is rear positioned, and the rotating material raking head is arranged in the space occupied by the raking and loading head power piece, so that a material raking arm of the rotating material raking head is lengthened, which is conducive to the raking and loading of large materials, thereby improving the raking and loading efficiency and the raking and loading performance.

11. When the left/right support up/down guide wheel piece and the left/right-righting telescopic arm guide roller are used, the support left/right-righting roller bracket is arranged on the left/right support up/down guide wheel piece or the telescopic arm bracket plate, the left/right-righting telescopic arm guide roller is arranged on the support left/right-righting roller bracket, and the left/right-righting telescopic arm guide roller is arranged in the roller arc groove, so that part of a roller body of the left/right-righting telescopic arm guide roller towards the direction of the attaching left/right-righting face protrudes from the notch of the roller arc groove, the protruding part is attached to the attaching left/right-righting face, and the left/right-righting telescopic arm guide roller rights the reciprocating stretching and retraction of the rolling friction telescopic arm. The left/right-righting telescopic arm guide roller has large righting force, strong impact resistance, simple structure, and few wearing parts, and reduces the left-right width of the low-thickness rolling guide telescopic rocker arm, so that the device better adapts to working in a narrow roadway.

12. When the holding telescopic arm guide wheel groove frame is used, the upper and lower support plate connecting piece is connected to the upper support plate of the guide wheel groove frame and the lower support plate of the guide wheel groove frame, so as to form the support guide wheel frame structure, and the up/down support telescopic arm guide wheel and the left/right-righting telescopic arm guide wheel are tightly combined in the support guide wheel frame structure, so that the space sequentially occupied by the up/down support telescopic arm guide wheel and the left/right-righting telescopic arm guide wheel is reduced, the telescopic length of the telescopic arm is relatively increased, and the support strength of the up/down support telescopic arm guide wheel and/or the left/right-righting telescopic arm guide wheel is enhanced. Or when the holding telescopic arm guide wheel groove block is used, the up/down support telescopic arm guide roller is arranged in the holding up/down guide wheel arc groove and/or the left/right-righting telescopic arm guide roller is arranged in the support left-right guide wheel arc groove. The diameters of the up/down support telescopic arm guide wheel and the left/right-righting telescopic arm guide wheel are reduced by using the up/down support telescopic arm guide roller and the left/right-righting telescopic arm guide roller, the diameter of the roller is thickened by the space occupied by the wheel skin, the overall width is reduced, the structural strength of rolling guide parts is improved, and the space occupied by the wheel skin is saved, so that the low-thickness rolling guide telescopic rocker arm has compact structure, strong practicability, few machining and manufacturing processes, less maintenance amount, and long service life, and relatively increases the telescopic length and saves the materials.

### BRIEF DESCRIPTION OF THE DRAWINGS

FIG. 1 is a schematic structural diagram of a low-thickness rolling guide telescopic rocker arm in Embodiment 1.

FIG. 2 is a partial structural sectional view of a low-thickness rolling guide telescopic rocker arm in Embodiment 1.

FIG. 3 is a partial schematic structural diagram of a low-thickness rolling guide telescopic rocker arm in Embodiment 1.

FIG. 4 is a partial schematic structural diagram of a low-thickness rolling guide telescopic rocker arm in Embodiment 1.

FIG. 5 is a partial schematic structural diagram of a low-thickness rolling guide telescopic rocker arm in Embodiment 1.

FIG. 6 is a partial structural sectional view of a low-thickness rolling guide telescopic rocker arm in Embodiment 1.

FIG. 7 is a partial schematic structural diagram of a low-thickness rolling guide telescopic rocker arm in Embodiment 1.

FIG. 8 is a partial structural sectional view of a low-thickness rolling guide telescopic rocker arm in Embodiment 1.

FIG. 9 is a partial schematic structural diagram of a low-thickness rolling guide telescopic rocker arm in Embodiment 1.

FIG. 10 is a partial structural sectional view of a low-thickness rolling guide telescopic rocker arm in Embodiment 1.

FIG. 11 is a partial structural sectional view of a low-thickness rolling guide telescopic rocker arm in Embodiment 2.

FIG. 12 is a partial structural sectional view of a low-thickness rolling guide telescopic rocker arm in Embodiment 2.

FIG. 13 is a partial schematic structural diagram of a low-thickness rolling guide telescopic rocker arm in Embodiment 2.

FIG. 14 is a partial structural sectional view of a low-thickness rolling guide telescopic rocker arm in Embodiment 3.

FIG. 15 is a partial schematic structural diagram of a low-thickness rolling guide telescopic rocker arm in Embodiment 3.

FIG. 16 is a partial structural sectional view of a low-thickness rolling guide telescopic rocker arm in Embodiment 3.

FIG. 17 is a partial structural sectional view of a low-thickness rolling guide telescopic rocker arm in Embodiment 3.

FIG. 18 is a partial structural sectional view of a low-thickness rolling guide telescopic rocker arm in Embodiment 4.

FIG. 19 is a partial schematic structural diagram of a low-thickness rolling guide telescopic rocker arm in Embodiment 4.

FIG. 20 is a partial structural sectional view of a low-thickness rolling guide telescopic rocker arm in Embodiment 4.

FIG. 21 is a partial schematic structural diagram of a low-thickness rolling guide telescopic rocker arm in Embodiment 4.

FIG. 22 is a partial structural sectional view of a low-thickness rolling guide telescopic rocker arm in Embodiment 4.

FIG. 23 is a partial structural sectional view of a low-thickness rolling guide telescopic rocker arm in Embodiment 4.

FIG. 24 is a partial structural sectional view of a low-thickness rolling guide telescopic rocker arm in Embodiment 5.

FIG. 25 is a partial schematic structural diagram of a low-thickness rolling guide telescopic rocker arm in Embodiment 6.

FIG. 26 is a partial schematic structural diagram of a low-thickness rolling guide telescopic rocker arm in Embodiment 7.

FIG. 27 is a partial structural sectional view of a low-thickness rolling guide telescopic rocker arm in Embodiment 7.

FIG. 28 is a partial schematic structural diagram of a low-thickness rolling guide telescopic rocker arm in Embodiment 8.

FIG. 29 is a partial structural sectional view of a low-thickness rolling guide telescopic rocker arm in Embodiment 8.

FIG. 30 is a partial structural sectional view of a low-thickness rolling guide telescopic rocker arm in Embodiment 8.

FIG. 31 is a partial structural sectional view of a low-thickness rolling guide telescopic rocker arm in Embodiment 8.

FIG. 32 is a partial structural sectional view of a low-thickness rolling guide telescopic rocker arm in Embodiment 8.

FIG. 33 is a partial structural sectional view of a low-thickness rolling guide telescopic rocker arm in Embodiment 9.

FIG. 34 is a partial structural sectional view of a low-thickness rolling guide telescopic rocker arm in Embodiment 10.

FIG. 35 is a partial structural sectional view of a low-thickness rolling guide telescopic rocker arm in Embodiment 10.

FIG. 36 is a partial structural sectional view of a low-thickness rolling guide telescopic rocker arm in Embodiment 11.

FIG. 37 is a partial schematic structural diagram of a low-thickness rolling guide telescopic rocker arm in Embodiment 11.

FIG. 38 is a partial schematic structural diagram of a low-thickness rolling guide telescopic rocker arm in Embodiment 11.

FIG. 39 is a partial structural sectional view of a low-thickness rolling guide telescopic rocker arm in Embodiment 11.

FIG. 40 is a partial schematic structural diagram of a low-thickness rolling guide telescopic rocker arm in Embodiment 12.

FIG. 41 is a partial structural sectional view of a low-thickness rolling guide telescopic rocker arm in Embodiment 12.

FIG. 42 is a partial schematic structural diagram of a low-thickness rolling guide telescopic rocker arm in Embodiment 13.

FIG. 43 is a partial schematic structural diagram of a low-thickness rolling guide telescopic rocker arm in Embodiment 14.

FIG. 44 is a partial schematic structural diagram of a low-thickness rolling guide telescopic rocker arm in Embodiment 15.

FIG. 45 is a partial schematic structural diagram of a low-thickness rolling guide telescopic rocker arm in Embodiment 16.

FIG. 46 is a partial schematic structural diagram of a low-thickness rolling guide telescopic rocker arm in Embodiment 17.

FIG. 47 is a partial schematic structural diagram of a low-thickness rolling guide telescopic rocker arm in Embodiment 18.

FIG. 48 is a partial schematic structural diagram of a low-thickness rolling guide telescopic rocker arm in Embodiment 18.

FIG. 49 is a partial schematic structural diagram of a low-thickness rolling guide telescopic rocker arm in Embodiment 18.

FIG. 50 is a partial schematic structural diagram of a low-thickness rolling guide telescopic rocker arm in Embodiment 19.

FIG. 51 is an A-A partial structural sectional view of FIG. 50.

FIG. 52 is a partial schematic structural diagram of a low-thickness rolling guide telescopic rocker arm in Embodiment 19.

FIG. 53 is a partial sectional view of a low-thickness rolling guide telescopic rocker arm in Embodiment 20.

FIG. 54 is a partial schematic structural diagram of a low-thickness rolling guide telescopic rocker arm in Embodiment 20.

In the figures: 1-low-thickness rolling guide telescopic rocker arm, 2-telescopic arm bracket, 3-rolling friction telescopic arm, 4-up/down-rolling support telescopic arm guide mechanism, 5-left/right-righting telescopic arm guide mechanism, 6-up/down support telescopic arm guide wheel, 7-up/down support telescopic arm guide piece, 8-up/down support guide axle, 9-up/down support sleeve wheel, 10-left/right-righting telescopic arm guide wheel, 11-left/right-righting telescopic arm guide piece, 12-hollow I-shaped buckle wheel telescopic arm, 13-square buckle groove roller telescopic arm, 14-buckling guide wheel groove, 15-left buckling guide wheel groove, 16-right buckling guide wheel groove, 17-upper face of left buckling support wheel, 18-lower face of left buckling support wheel, 19-left attaching left/right-righting face, 20-upper face of left buckling support wheel, 21-lower face of right buckling support wheel, 22-right attaching left/right-righting face, 23-left/right support up/down guide wheel piece, 24-up/down support telescopic arm piece, 25-telescopic arm bracket plate, 26-left support up/down guide wheel piece, 27-right support up/down guide wheel piece, 28-support up/down guide axle, 29-support up/down guide wheel bracket, 30-telescopic arm bracket support left/right-righting wheel bracket, 31-up/down guide wheel bracket support left/right-righting wheel bracket, 32-front left up/down support telescopic arm guide wheel, 33-rear left up/down support telescopic arm guide wheel, 34-front right up/down support telescopic arm guide wheel, 35-rear right up/down support telescopic arm guide wheel, 36-attaching left/right-righting face, 37-left front left/right-righting telescopic arm guide wheel, 38-left rear left/right-righting telescopic arm guide wheel, 39-right front left/right-righting telescopic arm guide wheel, 40-right rear left/right-righting telescopic arm guide wheel, 41-front face of buckling support wheel, 42-lower face of buckling support wheel, 43-front left left/right-righting telescopic arm guide piece, 44-rear left left/right-righting telescopic arm guide piece, 45-front right left/right-righting telescopic arm guide piece, 46-rear right left/right-righting telescopic arm guide piece, 47-orientation-fit attaching left/right-righting face guide wear-resistant part, 48-left/right-righting telescopic arm shaft, 49-left/right-righting telescopic arm wheel, 50-support left-right guide axle piece, 51-upper support left-right guide axle piece, 52-lower support left-right guide axle piece, 53-left/right-righting telescopic arm shaft wheel, 54-hollow I-shaped frame, 55-I-shaped hollow structure, 56-telescopic oil cylinder, 57-square telescopic frame, 58-flank roller mechanism, 59-up/down support telescopic arm roller, 60-left/right-righting telescopic arm roller, 61-left/right-righting telescopic arm guide plate, 62-up/down left/right guide wheel set, 63-left front up/down left/right guide wheel set, 64-left rear up/down left/right guide wheel set, 65-right front up/down left/right guide wheel set, 66-right rear up/down left/right guide wheel set, 67-bracket left buckle wheel groove, 68-bracket right buckle wheel groove, 69-upper plate of bracket left buckle wheel groove, 70-lower plate of bracket left buckle wheel groove, 71-upper plate of bracket right buckle wheel groove, 72-lower plate of bracket right buckle wheel groove, 73-wheel groove frame, 74-left wheel groove frame, 75-right wheel groove frame, 76-left support wheel groove frame piece, 77-right support wheel groove frame piece, 78-holding wheel groove frame plate, 79-front support guide wheel groove frame hole, 80-rear support guide wheel frame hole, 81-front left support guide axle hole, 82-rear left support guide axle hole, 83-roller plate left/right-righting telescopic arm piece, 84-embedded roller hole plate, 85-roller, 86-flat plate left/right-righting telescopic arm piece, 87-arc plate left/right-righting telescopic arm piece, 88-ball plate left/right-righting telescopic arm piece, 89-excavation head, 90-material raking and loading part, 91-rotating raking and loading machine, 92-rotating rolling friction telescopic arm, 93-hinged shaft rolling friction telescopic arm, 94-rotating telescopic arm structure, 95-telescopic arm hinged shaft, 96-support rotating swing arm structure, 97-rotating swing arm, 98-rotating raking and loading part, 99-support rotating arm swing shaft, 100-rotating swing arm driving piece, 101-rotating swing arm sleeve, 102-rotating arm connecting drive device, 103-material receiving, transporting and discharging part, 104-material receiving, transporting and discharging shovel plate, 105-polygonal material receiving, transporting and discharging shovel plate, 106-transmission power piece, 107-transmission channel, 108-raking and loading head power piece, 109-raking and loading head transmission piece, 110-transmission hose, 111-rotating material raking head, 112-fixed raking and loading head power piece structure, 113-gear transmission piece, 114-raking and loading head gear transmission piece, 115-swing arm gear transmission piece, 116-left/right-righting telescopic arm guide roller, 117-support left/right-righting roller bracket, 118-roller arc groove, 118.1-holding telescopic arm guide wheel groove frame, 119-up/down support telescopic arm guide roller, 120-upper support plate of guide wheel groove frame, 121-lower support plate of guide wheel groove frame, 122-upper and lower support plate connecting piece, 123-support guide wheel frame structure, 124-holding telescopic arm guide wheel groove block, 125-holding up/down guide wheel arc groove, and 126-support left-right guide wheel arc groove.

### DETAILED DESCRIPTION OF THE EMBODIMENTS

### Embodiment 1

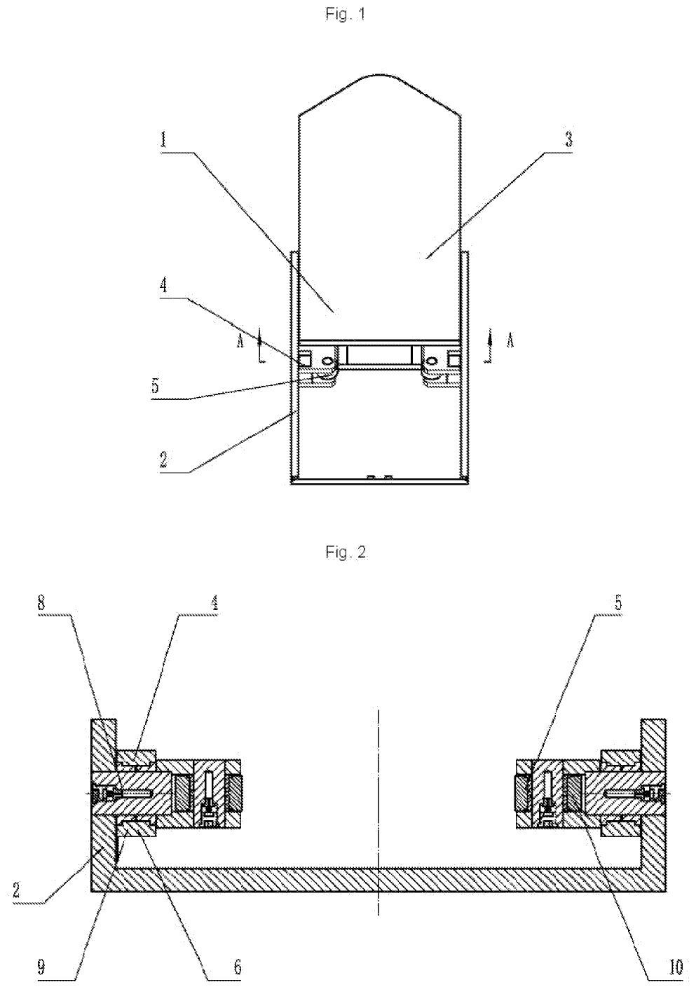

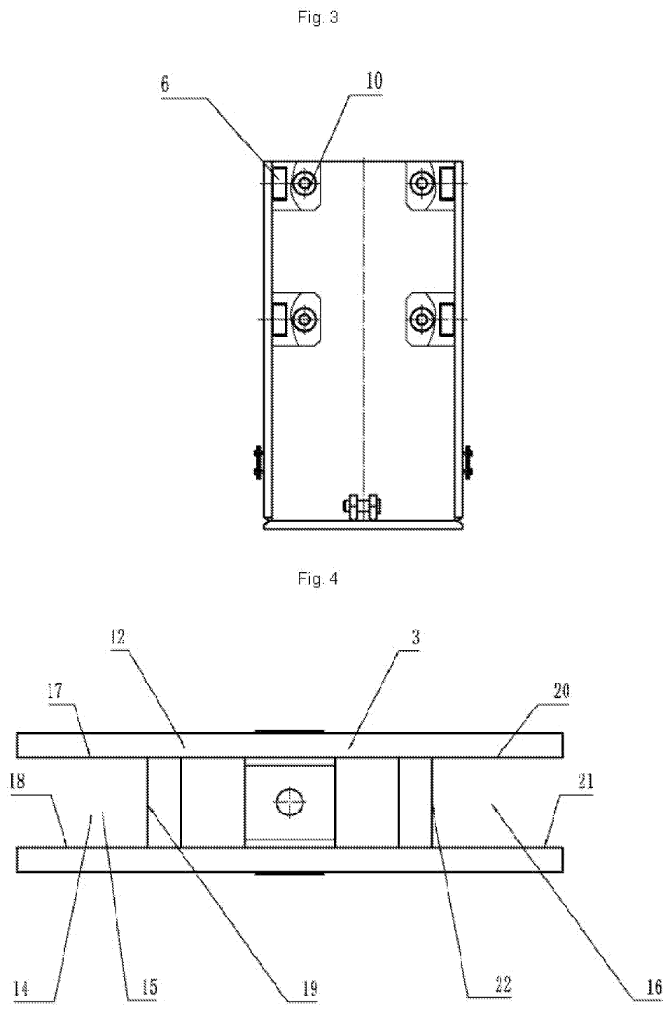

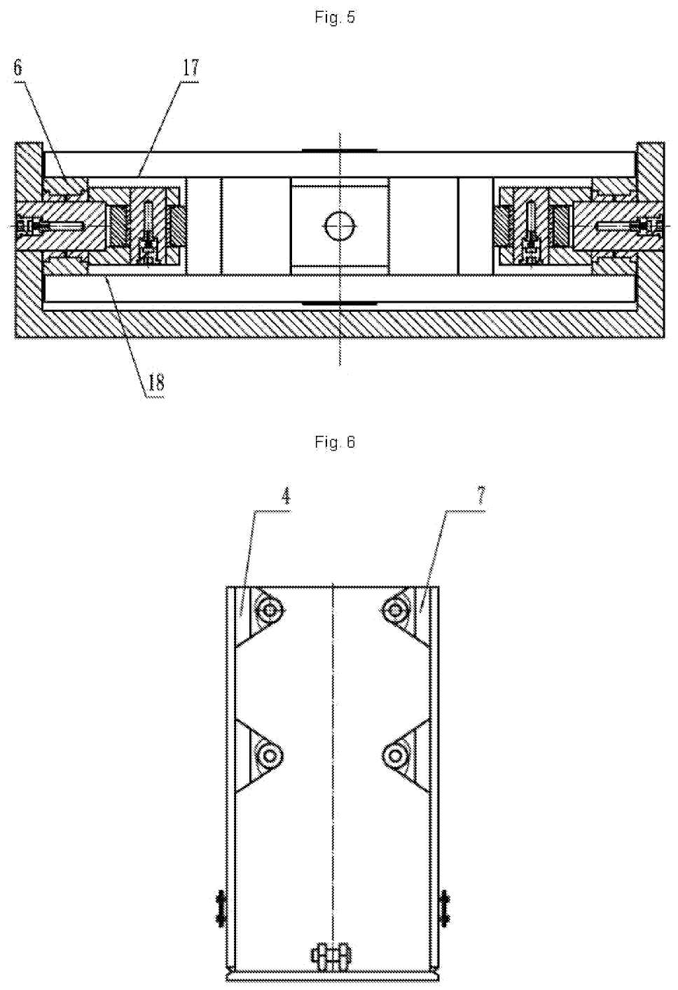

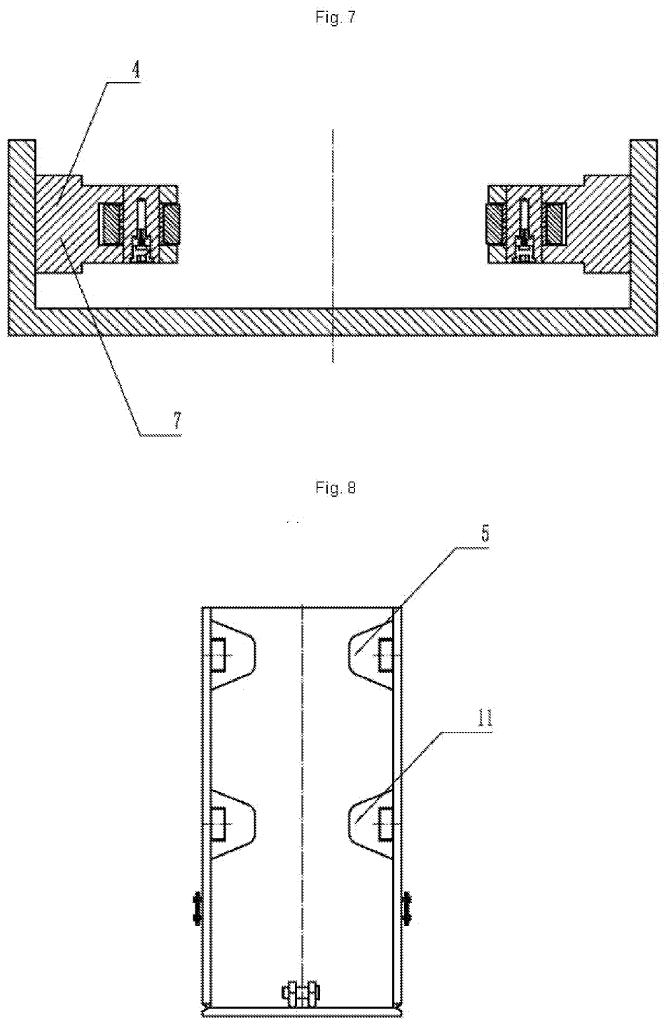

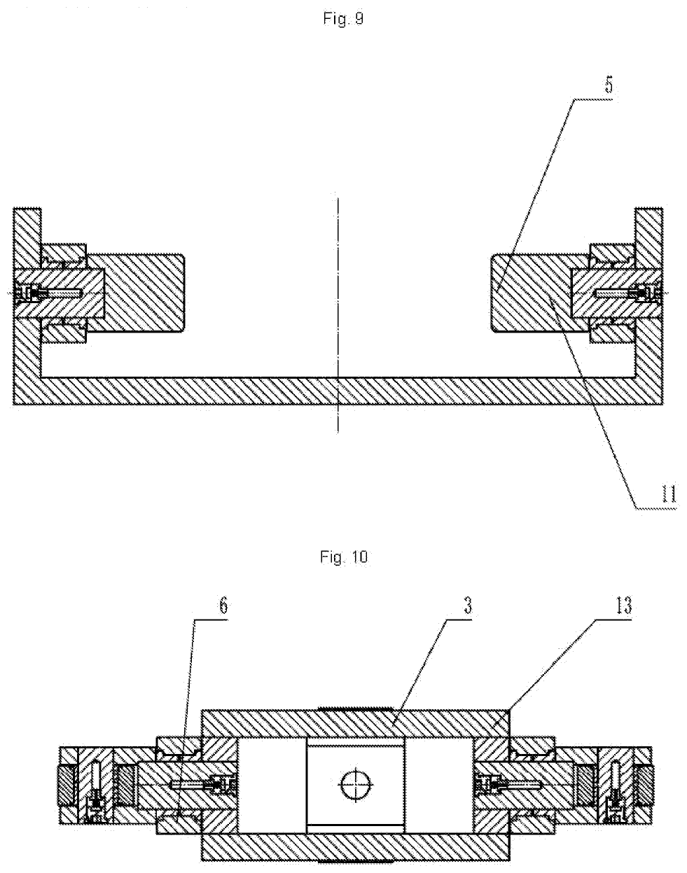

As shown in FIG. 1 to FIG. 10, a low-thickness rolling guide telescopic rocker arm 1 includes a telescopic arm bracket 2, a rolling friction telescopic arm 3, an up/down-rolling support telescopic arm guide mechanism 4, and a left/right-righting telescopic arm guide mechanism 5. The up/down-rolling support telescopic arm guide mechanism 4 includes an up/down support telescopic arm guide wheel 6. The up/down support telescopic arm guide wheel 6 includes an up/down support guide axle 8 and an up/down support sleeve wheel 9. The up/down support guide axle 8 and the up/down support sleeve wheel 9 are separately connected. The left/right-righting telescopic arm guide mechanism 5 includes a left/right-righting telescopic arm guide wheel 10. The up/down support telescopic arm guide wheel 6 is arranged on the telescopic arm bracket 2. The rolling friction telescopic arm 3 includes a hollow I-shaped buckle wheel telescopic arm 12. The hollow I-shaped buckle wheel telescopic arm 12 includes a buckling guide wheel groove 14. The buckling guide wheel groove 14 includes a left buckling guide wheel groove 15 and a right buckling guide wheel groove 16. The left buckling guide wheel groove 15 includes an upper face of a left buckling support wheel 17, a lower face of the left buckling support wheel 18, and a left attaching left/right-righting face 19. The up/down support telescopic arm guide wheel 6 rolls against the upper face of the left buckling support wheel 17, and the up/down support telescopic arm guide wheel 6 rolls against the lower face of the left buckling support wheel 18. The up/down support telescopic arm guide wheel 6 is matched with the upper face of the left buckling support wheel 17 and the lower face of the left buckling support wheel 18 to guide the rolling friction telescopic arm 3, so as to prevent the rolling friction telescopic arm 3 from shaking up and down during rolling friction stretching and retraction. The right buckling guide wheel groove 16 includes an upper face of a right buckling support wheel 20, a lower face of the right buckling support wheel 21, and a right attaching left/right-righting face 22.

The up/down-rolling support telescopic arm guide mechanism 4 also includes an up/down support telescopic arm guide piece 7.

The up/down support guide axle 8 and the up/down support sleeve wheel 9 also are integrated.

The left/right-righting telescopic arm guide mechanism 5 also includes a left/right-righting telescopic arm guide piece 11.

The up/down support telescopic arm guide wheel 6 also is arranged on the rolling friction telescopic arm 3, and the rolling friction telescopic arm 3 also includes a square buckle groove roller telescopic arm 13.

### Embodiment 2

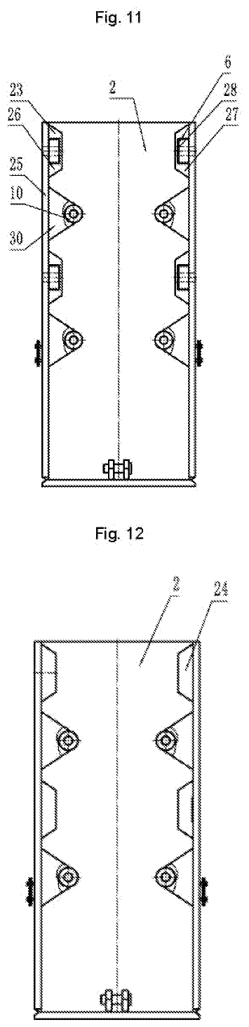

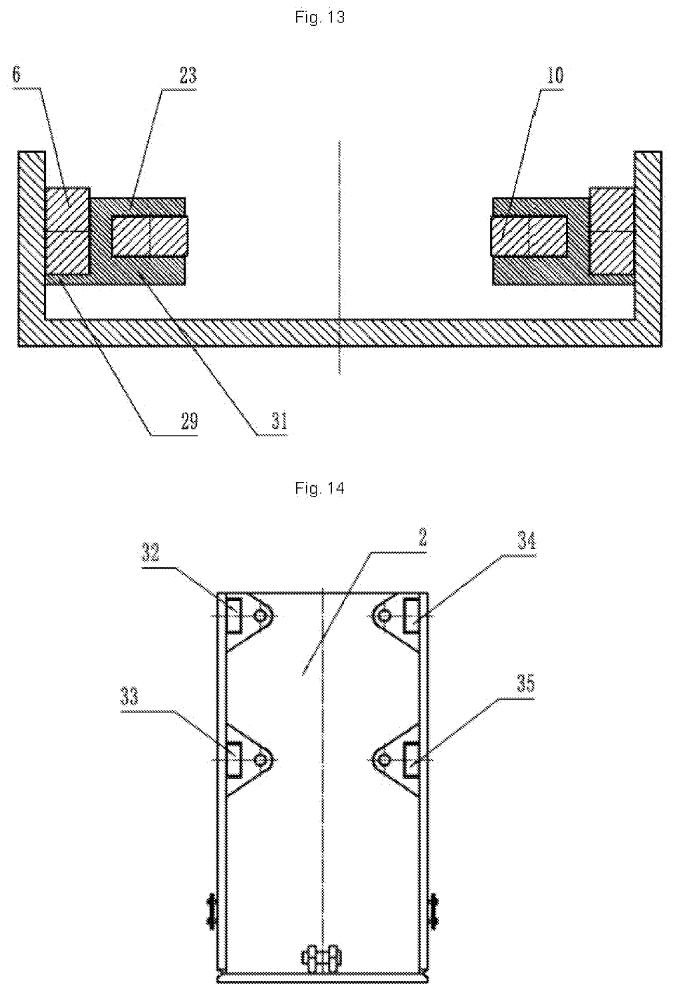

As shown in FIG. 11 to FIG. 13, a telescopic arm bracket 2 includes a left/right support up/down guide wheel piece 23. The telescopic arm bracket 2 further includes a telescopic arm bracket plate 25. The left/right support up/down guide wheel piece 23 includes a left support up/down guide wheel piece 26 and a right support up/down guide wheel piece 27. The left support up/down guide wheel piece 26 and the right support up/down guide wheel piece 27 are arranged on the telescopic arm bracket plate 25. When the left/right support up/down guide wheel piece 23 and a left/right-righting telescopic arm guide wheel 10 are used, a support up/down guide axle 28 is arranged on the left/right support up/down guide wheel piece 23, an up/down support telescopic arm guide wheel 6 is arranged on the support up/down guide axle 28, a telescopic arm bracket support left/right-righting wheel bracket 30 is arranged on the telescopic arm bracket plate 25, and the left/right-righting telescopic arm guide wheel 10 is arranged on the telescopic arm bracket support left/right-righting wheel bracket 30.

The telescopic arm bracket 2 also includes an up/down support telescopic arm piece 24.

The left/right support up/down guide wheel piece 23 also includes the left support up/down guide wheel piece 26 or the right support up/down guide wheel piece 27. The left support up/down guide wheel piece 26 or the right support up/down guide wheel piece 27 also is arranged on the telescopic arm bracket plate 25.

A support up/down guide wheel bracket 29 also is arranged on the left/right support up/down guide wheel piece 23, the up/down support telescopic arm guide wheel 6 also is arranged on the support up/down guide wheel bracket 29, a telescopic arm bracket support left/right-righting wheel bracket 31 also is arranged on the support up/down guide wheel bracket 29, and the left/right-righting telescopic arm guide wheel 10 also is arranged on the up/down guide wheel bracket support left/right-righting wheel bracket 31.

Others are the same as Embodiment 1.

### Embodiment 3

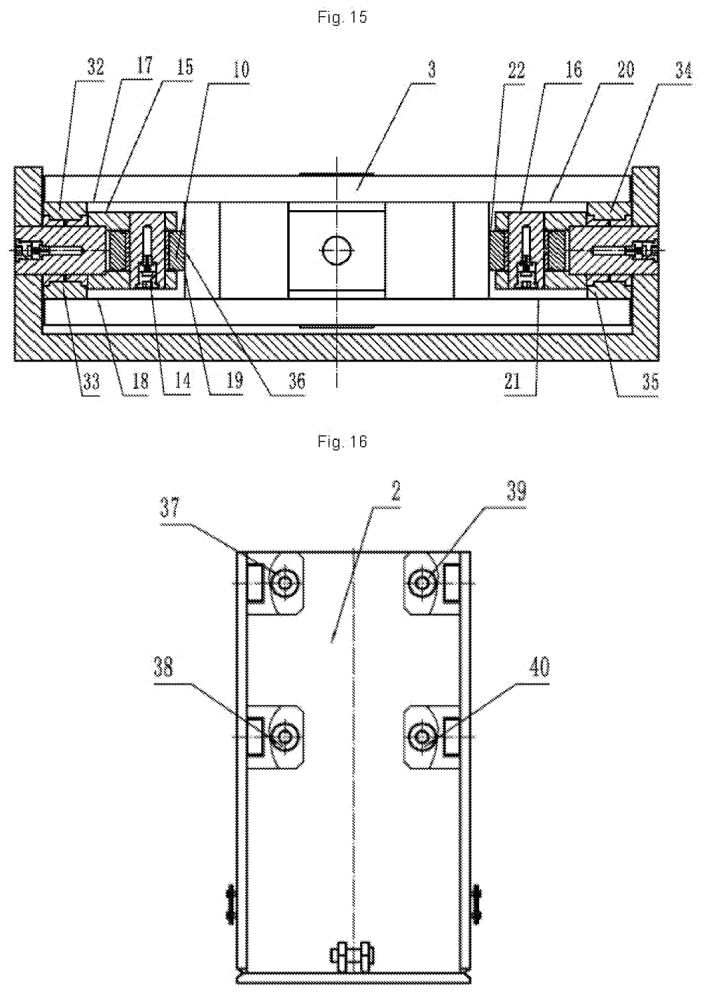

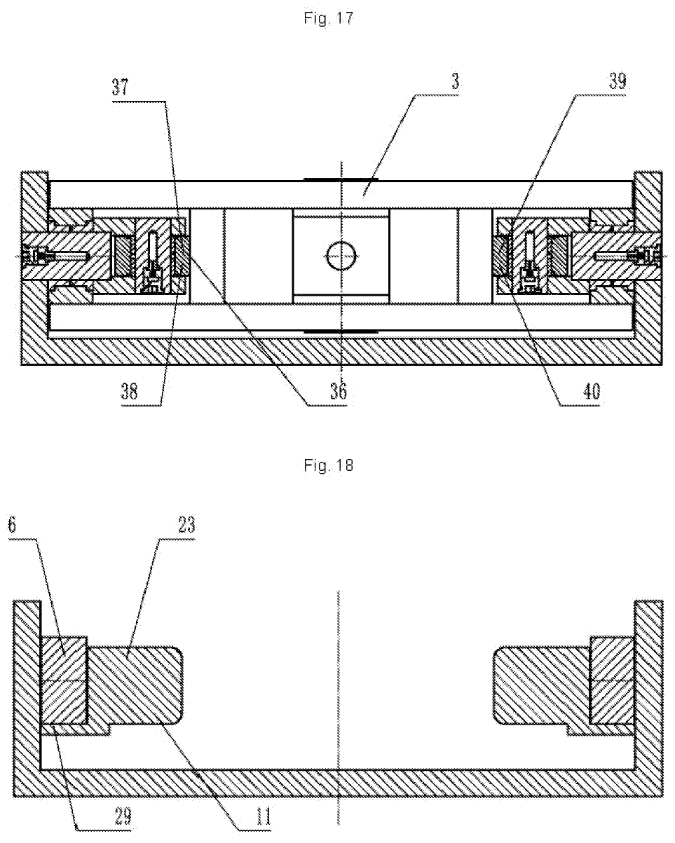

As shown in FIG. 14 to FIG. 17, a left buckling guide wheel groove 15 and a right buckling guide wheel groove 16 are arranged on both sides of a rolling friction telescopic arm 3. A front left up/down support telescopic arm guide wheel 32, a rear left up/down support telescopic arm guide wheel 33, a front right up/down support telescopic arm guide wheel 34, and a rear right up/down support telescopic arm guide wheel 35 are arranged on a telescopic arm bracket 2. The front left up/down support telescopic arm guide wheel 32 and the rear left up/down support telescopic arm guide wheel 33 are arranged in the left buckling guide wheel groove 15 and between an upper face of a left buckling support wheel 17 and a lower face of the left buckling support wheel 18. The front right up/down support telescopic arm guide wheel 34 and the rear right up/down support telescopic arm guide wheel 35 are arranged in the right buckling guide wheel groove 16 and between an upper face of a right buckling support wheel 20 and a lower face of the right buckling support wheel 21. A left attaching left/right-righting face 19 and a right attaching left/right-righting face 22 form an attaching left/right-righting face 36. A left/right-righting telescopic arm guide wheel 10 is arranged in a buckling guide wheel groove 14 and a surface thereof is attached to the attaching left/right-righting face 36. The front left up/down support telescopic arm guide wheel 32 and the rear left up/down support telescopic arm guide wheel 33 support and guide the rolling friction telescopic arm 3 through the upper face of the left buckling support wheel 17 and the lower face of the left buckling support wheel 18, and the front right up/down support telescopic arm guide wheel 34 and the rear right up/down support telescopic arm guide wheel 35 support and guide the rolling friction telescopic arm 3 through the upper face of the right buckling support wheel 20 and the lower face of the right buckling support wheel 21, so as to prevent the rolling friction telescopic arm 3 from shaking up and down. The telescopic arm bracket 2 is provided with a left front left/right-righting telescopic arm guide wheel 37, a left rear left/right-righting telescopic arm guide wheel 38, a right front left/right-righting telescopic arm guide wheel 39, and a right rear left/right-righting telescopic arm guide wheel 40. The left front left/right-righting telescopic arm guide wheel 37, the left rear left/right-righting telescopic arm guide wheel 38, the right front left/right-righting telescopic arm guide wheel 39, and the right rear left/right-righting telescopic arm guide wheel 40 guide the rolling friction telescopic arm 3 through the attaching left/right-righting face 36, so as to prevent the rolling friction telescopic arm 3 from shaking left and right.

Others are the same as Embodiment 1.

### Embodiment 4

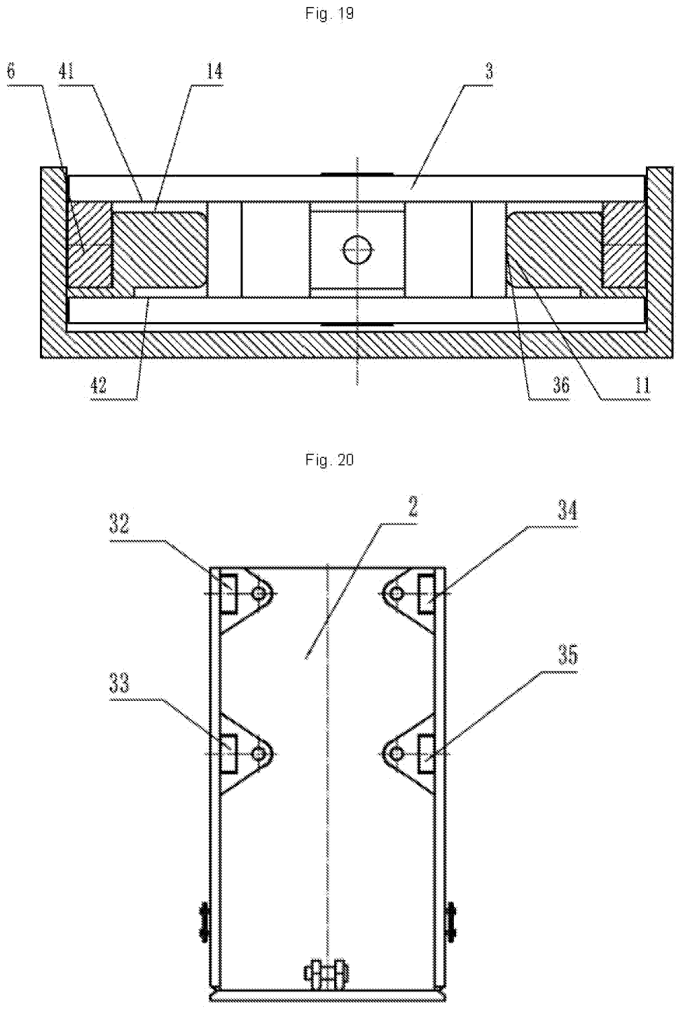

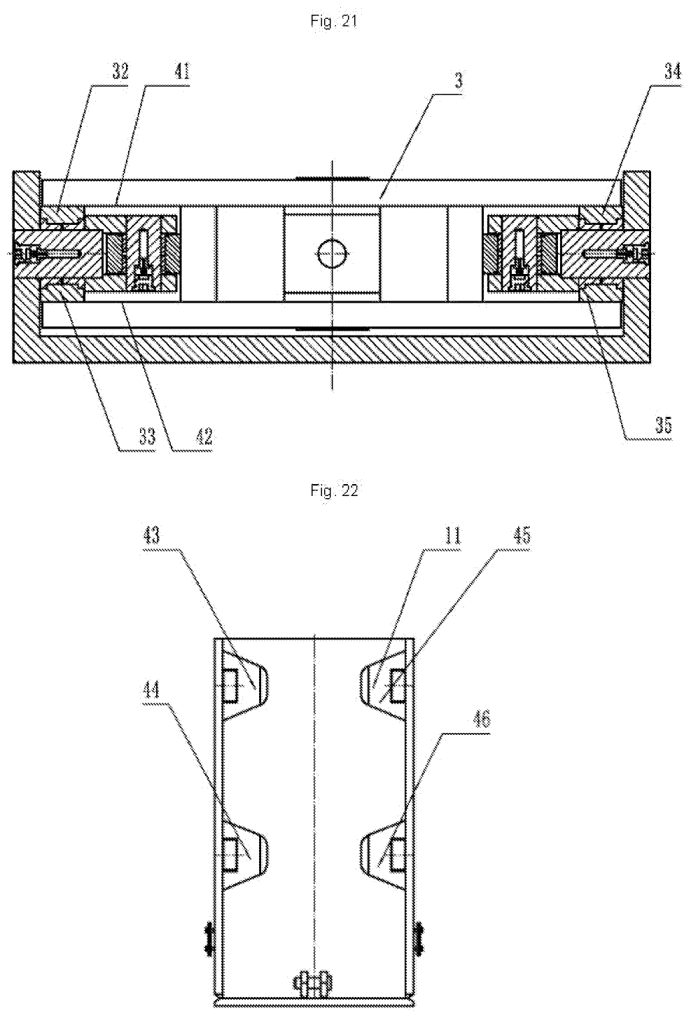

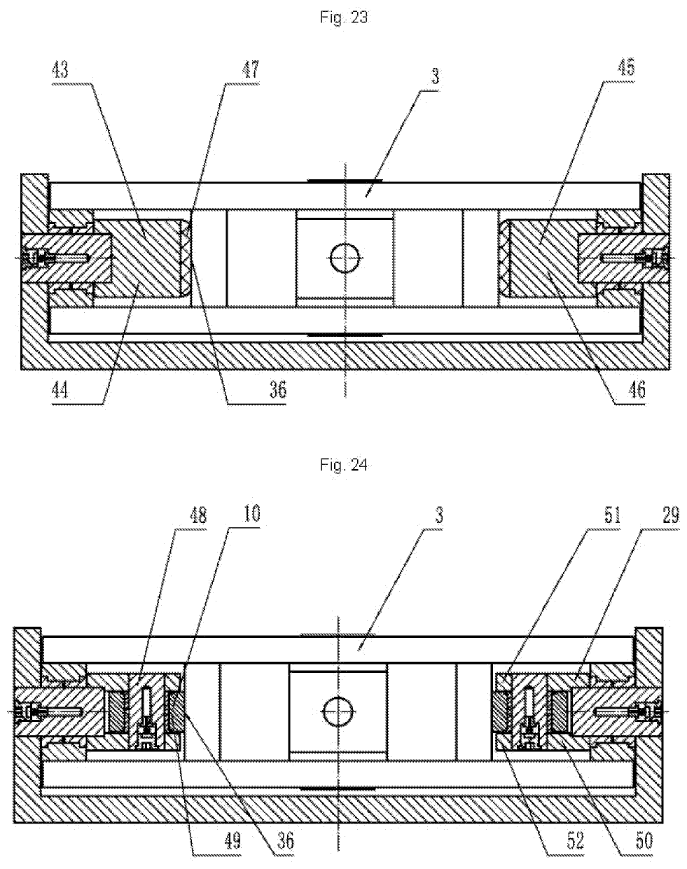

As shown in FIG. 18 to FIG. 23, when a left/right support up/down guide wheel piece 23 and a left/right-righting telescopic arm guide piece 11 are used, a support up/down guide wheel bracket 29 is arranged on the left/right support up/down guide wheel piece 23, an up/down support telescopic arm guide wheel 6 is arranged on the support up/down guide wheel bracket 29, the left/right-righting telescopic arm guide piece 11 is arranged on the support up/down guide wheel bracket 29, and the left/right-righting telescopic arm guide piece 11 and the support up/down guide wheel bracket 29 are separately connected. A buckling guide wheel groove 14 is arranged on both sides of a rolling friction telescopic arm 3. The buckling guide wheel groove 14 includes a front face of a buckling support wheel 41, a lower face of the buckling support wheel 42, and an attaching left/right-righting face 36. The up/down support telescopic arm guide wheel 6 is arranged in the buckling guide wheel groove 14 and between the upper face of the buckling support wheel 41 and the lower face of the buckling support wheel 42. The left/right-righting telescopic arm guide piece 11 is arranged in the buckling guide wheel groove 14 and a surface thereof is attached to the attaching left/right-righting face 36. A front left up/down support telescopic arm guide wheel 32, a rear left up/down support telescopic arm guide wheel 33, a front right up/down support telescopic arm guide wheel 34, and a rear right up/down support telescopic arm guide wheel 35 are arranged on a telescopic arm bracket 2. The front left up/down support telescopic arm guide wheel 32, the rear left up/down support telescopic arm guide wheel 33, the front right up/down support telescopic arm guide wheel 34, and the rear right up/down support telescopic arm guide wheel 35 support and guide the rolling friction telescopic arm 3 through the upper face of the buckling support wheel 41 and the lower face of the buckling support wheel 42, so as to prevent the rolling friction telescopic arm 3 from shaking left and right. The left/right-righting telescopic arm guide piece 11 includes a front left left/right-righting telescopic arm guide piece 43, a rear left left/right-righting telescopic arm guide piece 44, a front right left/right-righting telescopic arm guide piece 45, and a rear right left/right-righting telescopic arm guide piece 46. Orientation-fit attaching left/right-righting face guide wear-resistant parts 47 are arranged on the front left left/right-righting telescopic arm guide piece 43, the rear left left/right-righting telescopic arm guide piece 44, the rear left left/right-righting telescopic arm guide piece 45, and the rear right left/right-righting telescopic arm guide piece 46. The front left left/right-righting telescopic arm guide piece 43, the rear left left/right-righting telescopic arm guide piece 44, the rear left left/right-righting telescopic arm guide piece 45, and the rear right left/right-righting telescopic arm guide piece 46 guide the rolling friction telescopic arm 3 through the attaching left/right-righting face 36, so as to prevent the rolling friction telescopic arm 3 from shaking left and right.

When the left/right support up/down guide wheel piece 23 and the left/right-righting telescopic arm guide piece 11 are used, a support up/down guide axle 28 also is arranged on the left/right support up/down guide wheel piece 23, the up/down support telescopic arm guide wheel 6 also is arranged on the support up/down guide axle 28, and the left/right-righting telescopic arm guide piece 11 also is arranged on the end of the support up/down guide axle 28.

The left/right-righting telescopic arm guide piece 11 and the support up/down guide wheel bracket 29 also are integrated.

Others are the same as Embodiment 1.

### Embodiment 5

As shown in FIG. 24, a left/right-righting telescopic arm guide wheel 10 includes a left/right-righting telescopic arm shaft 48 and a left/right-righting telescopic arm wheel 49. The left/right-righting telescopic arm shaft 48 penetrates through the left/right-righting telescopic arm wheel 49 to guide the rolling friction of a rolling friction telescopic arm 3 left and right. A support left-right guide axle piece 50 is arranged on an end face of a support up/down guide wheel bracket 29 towards an attaching left/right-righting face 36 of the rolling friction telescopic arm 3. The support left-right guide axle piece 50 includes an upper support left-right guide axle piece 51 and a lower support left-right guide axle piece 52. The upper support left-right guide axle piece 51 and the lower support left-right guide axle piece 52 support the left/right-righting telescopic arm shaft 48. The left/right-righting telescopic arm shaft 48 penetrates through the left/right-righting telescopic arm shaft 49 to guide the rolling friction of the telescopic arm 3 left and right.

Others are the same as Embodiment 1.

### Embodiment 6

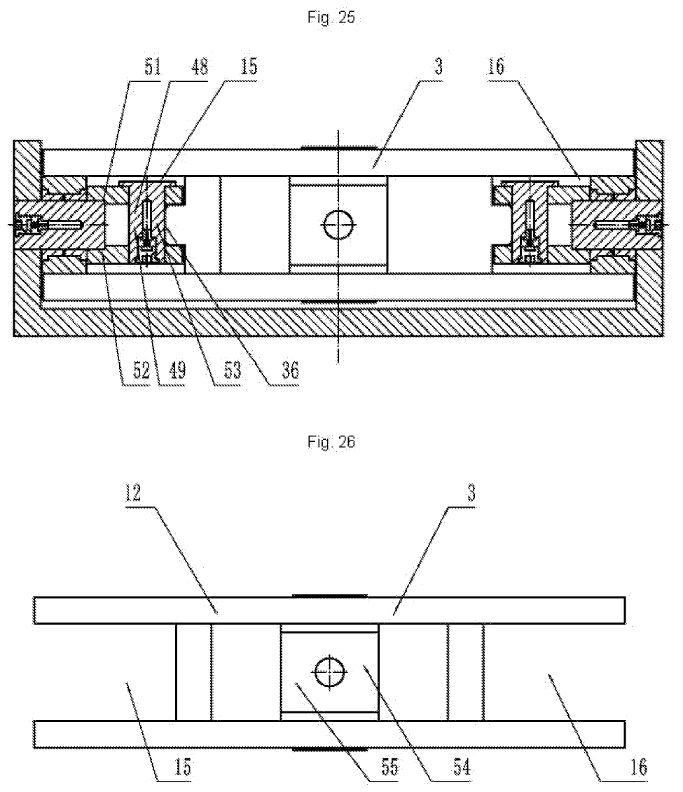

As shown in FIG. 25, when a left/right-righting telescopic arm shaft 48 and a left/right-righting telescopic arm wheel 49 are integrated, the left/right-righting telescopic arm shaft 48 and the left/right-righting telescopic arm wheel 49 form a left/right-righting telescopic arm shaft wheel 53, an upper support left-right guide axle piece 51 and a lower support left-right guide axle piece 52 support the left/right-righting telescopic arm shaft wheel 53, an attaching left/right-righting face 36 protrudes from the bottom of a left buckling guide wheel groove 15 and a right buckling guide wheel groove 16 to the side of the left/right-righting telescopic arm shaft wheel 53, the protruding length of the attaching left/right-righting face 36 makes the left/right-righting telescopic arm shaft wheel 53 abut against the attaching left/right-righting face 36, and the left/right-righting telescopic arm shaft wheel 53 rotates to guide the rolling friction of a rolling friction telescopic arm 3 left and right.

Others are the same as Embodiment 1.

### Embodiment 7

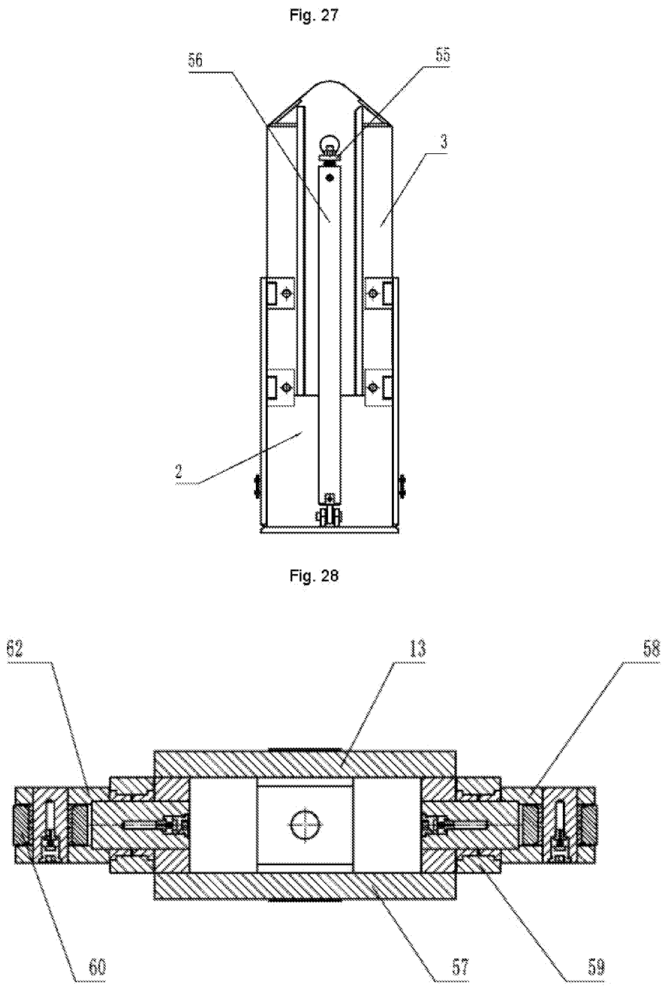

As shown in FIG. 26 to FIG. 27, a rolling friction telescopic arm 3 includes a hollow I-shaped buckle wheel telescopic arm 12. When the hollow I-shaped buckle wheel telescopic arm 12 is used, the hollow I-shaped buckle wheel telescopic arm 12 includes a hollow I-shaped frame 43. A left buckling guide wheel groove 15 and a right buckling guide wheel groove 16 are arranged on both sides of the hollow I-shaped buckle wheel telescopic arm 12. The hollow I-shaped frame 54 includes an I-shaped hollow structure 55. The rolling friction telescopic arm 3 includes a telescopic oil cylinder 56. A front end of the telescopic oil cylinder 56 is connected to a front part of the I-shaped hollow structure 55, and a rear end of the telescopic oil cylinder 56 is connected to a telescopic arm bracket 2. The telescopic oil cylinder 56 stretches and retracts to drive the rolling friction telescopic arm 3 to stretch and retract.

Others are the same as Embodiment 1.

### Embodiment 8

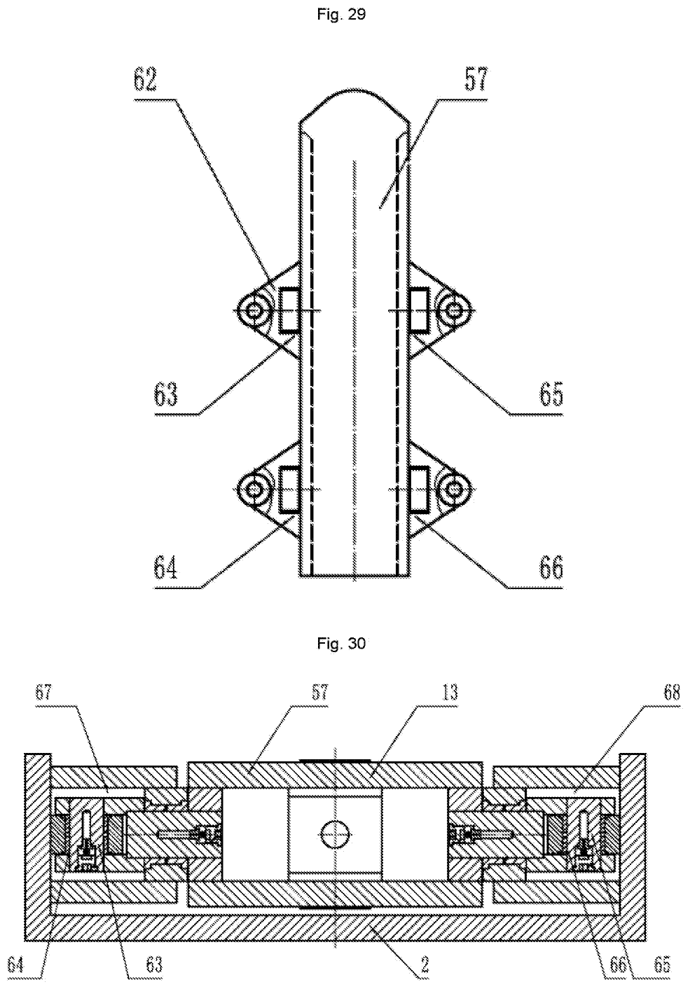

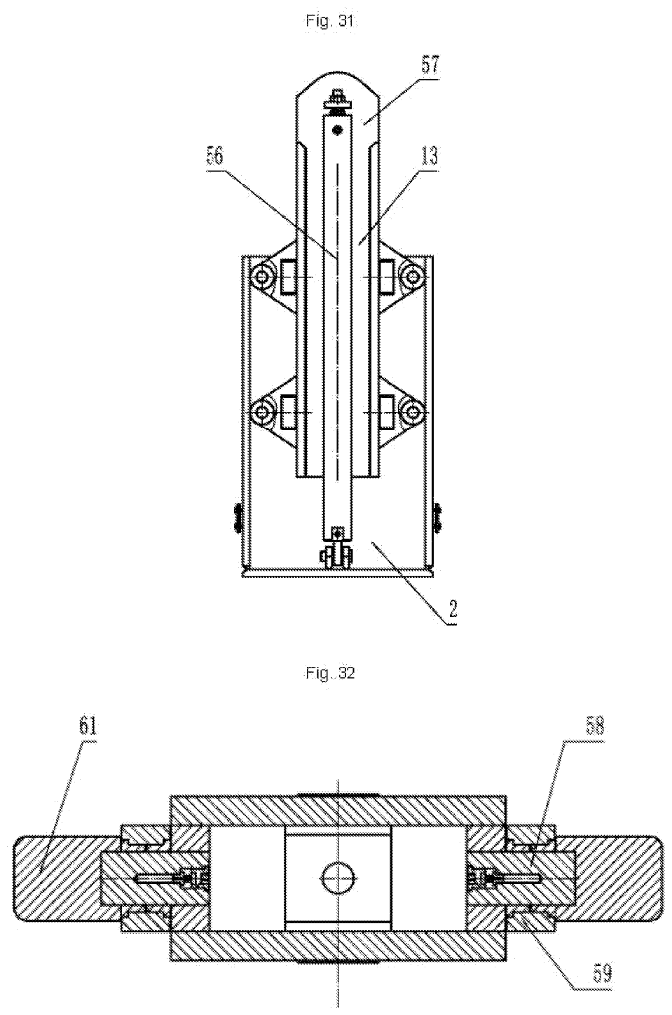

As shown in FIG. 28 to FIG. 32, when a square buckle groove roller telescopic arm 13 is used, the square buckle groove roller telescopic arm 13 includes a square telescopic frame 57 and a flank roller mechanism 58. The flank roller mechanism 58 is arranged on both sides of the square telescopic frame 57. The flank roller mechanism 58 includes an up/down support telescopic arm roller 59 and a left/right-righting telescopic arm roller 60. The up/down support telescopic arm roller 59 and the left/right-righting telescopic arm roller 60 form an up/down left/right guide wheel set 62. The up/down left/right guide wheel set 62 includes a left front up/down left/right guide wheel set 63, a left rear up/down left/right guide wheel set 64, a right front up/down left/right guide wheel set 65, and a right rear up/down left/right guide wheel set 66. The left front up/down left/right guide wheel set 63 and the left rear up/down left/right guide wheel set 64 are sequentially arranged on a left side of the square telescopic frame 57, and the right front up/down left/right guide wheel set 65 and the right rear up/down left/right guide wheel set 66 are sequentially arranged on a right side of the square telescopic frame 57. A telescopic arm bracket 2 includes a bracket left buckle wheel groove 67 and a bracket right buckle wheel groove 68. The left front up/down left/right guide wheel set 63 and the left rear up/down left/right guide wheel set 64 are arranged in the bracket left buckle wheel groove 67, and the right front up/down left/right guide wheel set 65 and the right rear up/down left/right guide wheel set 66 are arranged in the bracket right buckle wheel groove 68. The left front up/down left/right guide wheel set 63, the left rear up/down left/right guide wheel set 64, the right front up/down left/right guide wheel set 65, and the right rear up/down left/right guide wheel set 66 support the square telescopic frame 57. One end of a telescopic oil cylinder 56 is connected to a front part of the square telescopic frame 57, while the other end thereof is connected to the telescopic arm bracket 2. The telescopic oil cylinder 56 stretches and retracts to drive the square buckle groove roller telescopic arm 13 to stretch and retract.

The flank roller mechanism 58 also includes the up/down support telescopic arm roller 59 and a left/right-righting telescopic arm guide plate 61.

Others are the same as Embodiment 1.

### Embodiment 9

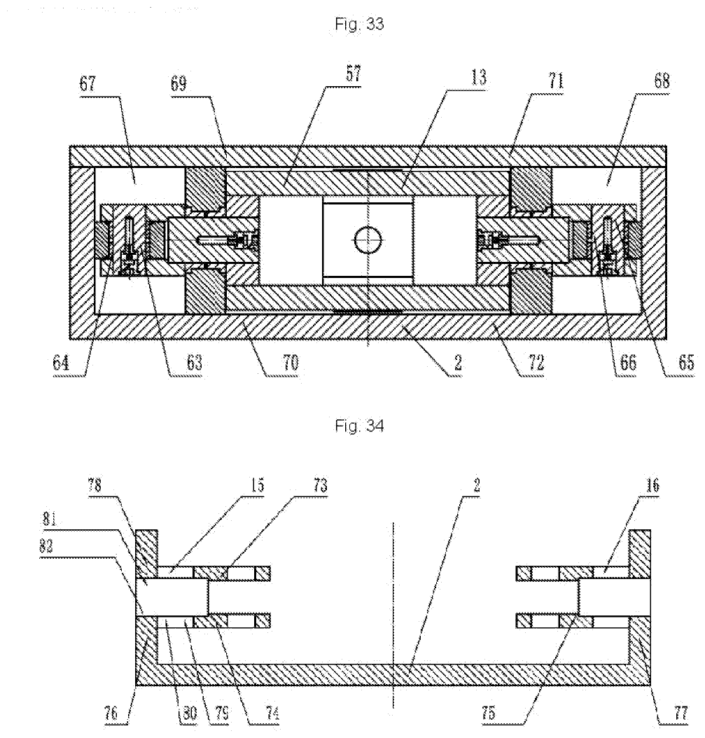

As shown in FIG. 33, a left buckle wheel groove of a bracket 67 includes an upper plate of a bracket left buckle wheel groove 69 and a lower plate of the bracket left buckle wheel groove 70. The bracket right buckle wheel groove 68 includes an upper plate of a bracket right buckle wheel groove 71 and a lower plate of the bracket right buckle wheel groove 72. The upper plate of the bracket left buckle wheel groove 69 and the upper plate of the bracket right buckle wheel groove 71 are integrated, and the lower plate of the bracket left buckle wheel groove 70 and the lower plate of the bracket right buckle wheel groove 72 are integrated.

The upper plate of the bracket left buckle wheel groove 69 and the upper plate of the bracket right buckle wheel groove 71 also are separated, and the lower plate of the bracket left buckle wheel groove 70 and the lower plate of the bracket right buckle wheel groove 72 also are separated.

Others are the same as Embodiment 1.

### Embodiment 10

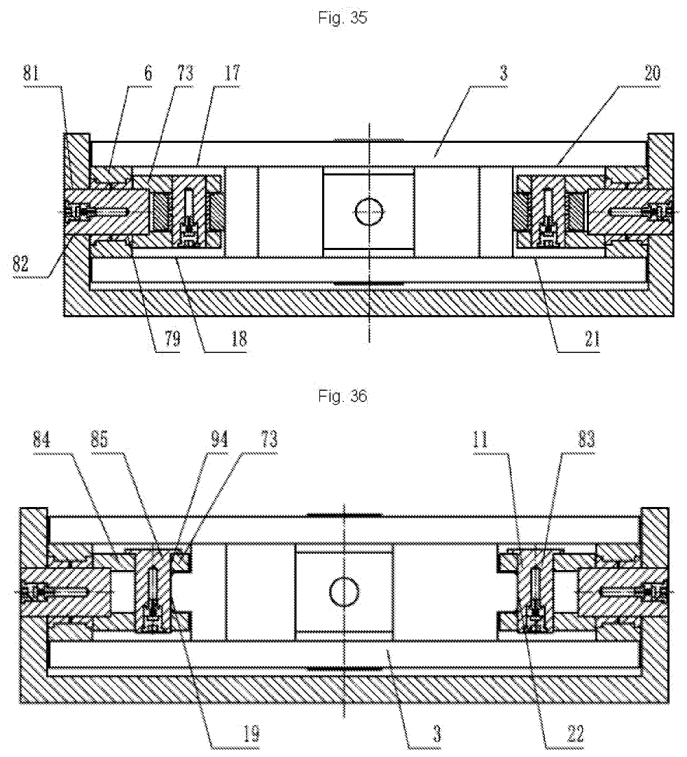

As shown in FIG. 34 to FIG. 35, a telescopic arm bracket 2 includes a wheel groove frame 73. The wheel groove frame 73 includes a left wheel groove frame 74 and a right wheel groove frame 75. The telescopic arm bracket 2 further includes a left support wheel groove frame piece 76 and a right support wheel groove frame piece 77. The left wheel groove frame 74 is arranged on the left support wheel groove frame piece 76, and the right wheel groove frame 75 is arranged on the right support wheel groove frame piece 77. The telescopic arm bracket 2 includes a holding wheel groove frame plate 78. The wheel groove frame 73 is arranged on the side of the holding wheel groove frame plate 78. A gap for placing a left buckling guide wheel groove 15 and a right buckling guide wheel groove 16 is arranged between the wheel groove frame 73 and the holding wheel groove frame plate 78. A front support guide wheel groove frame hole 79 and a rear support guide wheel groove frame hole 80 are arranged on the left wheel groove frame 74. A front left support guide axle hole 81 and a rear left support guide axle hole 82 are correspondingly arranged in the left support wheel groove frame piece 76. An up/down support telescopic arm guide wheel 6 is arranged in the front support guide wheel groove frame hole 79, and supported by the front left support guide axle hole 81 and the rear left support guide axle hole 82. The surface of the up/down support telescopic arm guide wheel 6 is higher than the surface of the wheel groove frame 73. The upper and lower surfaces of the up/down support telescopic arm guide wheel 6 are respectively matched with an upper face of a left buckling support wheel 17 and a lower face of the left buckling support wheel 18 in parallel, the lower face of the left buckling support wheel 18 and a lower face of a right buckling support wheel 21 support a rolling friction telescopic arm 3, and the upper face of the left buckling support wheel 17 and the upper face of the right buckling support wheel 20 limit the rolling friction telescopic arm 3 to tilt up.

The wheel groove frame 73 also includes the left wheel groove frame 74 or the right wheel groove frame 75. The telescopic arm bracket 2 also includes the left support wheel groove frame piece 76 or the right support wheel groove frame piece 77.

The front support guide wheel groove frame hole 79 or the rear support guide wheel groove frame hole 80 also is arranged in the left wheel groove frame 74. The front left support guide axle hole 81 or the rear left support guide axle hole 82 also is correspondingly arranged in the left support wheel groove frame piece 76, which is by the front left support guide axle hole 81 or the rear left support guide axle hole 82.

Others are the same as Embodiment 1.

### Embodiment 11

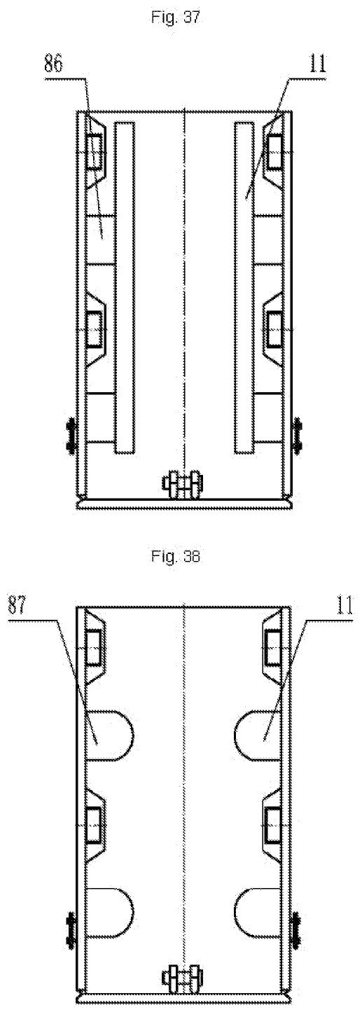

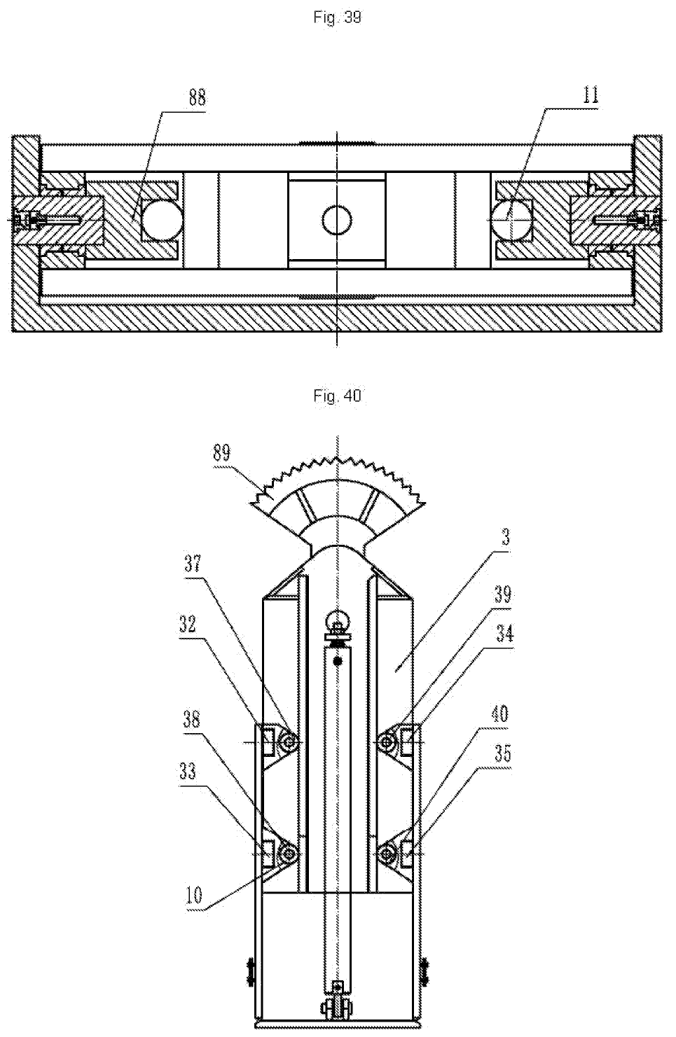

As shown in FIG. 36 to FIG. 39, a left/right-righting telescopic arm guide piece 11 includes a roller plate left/right-righting telescopic arm piece 83. When the roller plate left/right-righting telescopic arm piece 83 is used, the roller plate left/right-righting telescopic arm piece 83 includes an embedded roller hole plate 84 and a roller 85. The width of the roller hole exposed on the embedded roller hole plate 84 is less than the diameter of the roller 85, the embedded roller hole plate 84 is fixed to a wheel groove frame 73, the roller 85 is arranged on the embedded roller hole plate 84, a cylinder part thereof exposes the embedded roller hole plate, and a roller surface is attached to a left attaching left/right-righting face 19 and a right attaching left/right-righting face 22, so as to right a rolling friction telescopic arm 3 left and right.

The left/right-righting telescopic arm guide piece 11 also includes a flat plate left/right-righting telescopic arm 86 or an arc plate left/right-righting telescopic arm 87 or a ball plate left/right-righting telescopic arm or a hole plate left/right-righting telescopic arm piece or a groove plate left/right-righting telescopic arm piece.

The roller surface also is attached to the left attaching left/right-righting face 19 or the right attaching left/right-righting face 22.

Others are the same as Embodiment 1.

### Embodiment 12

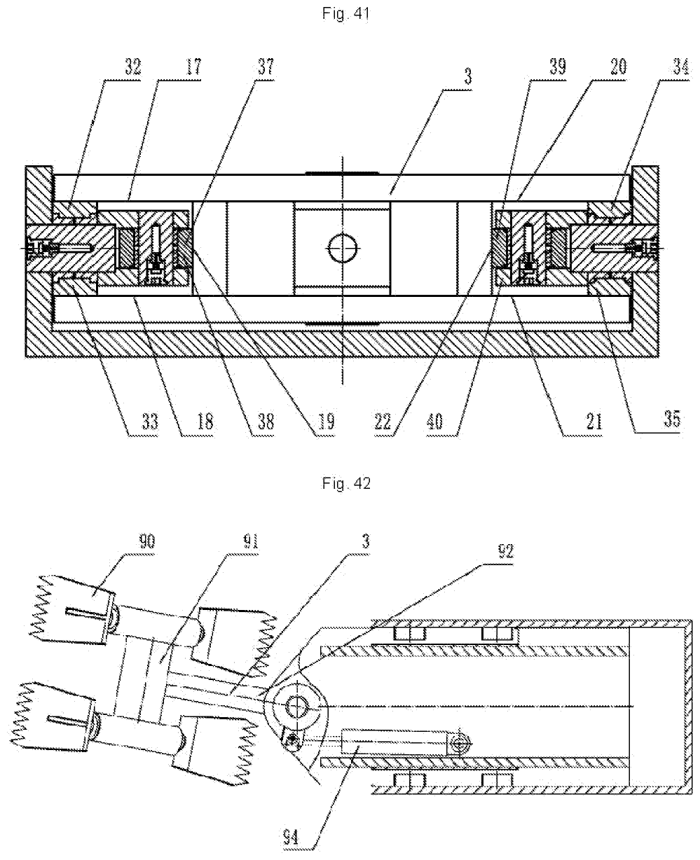

As shown in FIG. 40 to FIG. 41, a front end of a rolling friction telescopic arm 3 is provided with an excavation head 89. When the rolling friction telescopic arm 3 stretches and retracts forwards, a wheel face of a front left up/down support telescopic arm guide wheel 32 is attached to an upper face of a left buckling support wheel 17, a wheel face of a rear left up/down support telescopic arm guide wheel 33 is attached to a lower face of the left buckling support wheel 18, a wheel face of a front right up/down support telescopic arm guide wheel 34 is attached to an upper face of a right buckling support wheel 20, and a wheel face of a right rear up/down support telescopic arm guide wheel 35 is attached to a lower face of the right buckling support wheel 21. A left/right-righting telescopic arm guide wheel 10 includes a left front left/right-righting telescopic arm guide wheel 37, a right front left/right-righting telescopic arm guide wheel 39, a left rear left/right-righting telescopic arm guide wheel 38, and a right rear left/right-righting telescopic arm guide wheel 40. The wheel faces of the left front left/right-righting telescopic arm guide wheel 37 and the left rear left/right-righting telescopic arm guide wheel 38 are attached to a left attaching left/right-righting face 19, and the wheel faces of the right front left/right-righting telescopic arm guide wheel 39 and the right rear left/right-righting telescopic arm guide wheel 40 are attached to a right attaching left/right-righting face 22. The left front left/right-righting telescopic arm guide wheel 37, the right front left/right-righting telescopic arm guide wheel 39, the left rear left/right-righting telescopic arm guide wheel 38, and the right rear left/right-righting telescopic arm guide wheel 40 are attached to a left/right-righting face 36 to prevent the rolling friction telescopic arm 3 from shaking left and right. A distance between the upper face of the left buckling support wheel 17 and the lower face of the left buckling support wheel 18 is greater than the diameter of an up/down support telescopic arm guide wheel 6, and the spacing range is no more than 10 mm, so that the excavation head 89 or a material raking head or an impact head is stably supported.

The front end of the rolling friction telescopic arm 3 also is provided with the material raking head or the impact head.

The distance between the upper face of the left buckling support wheel 17 and the lower face of the left buckling support wheel 18 also is equal to the diameter of the up/down support telescopic arm guide wheel 6, so that the material raking head or the impact head is stably supported.

Others are the same as Embodiment 1.

### Embodiment 13

As shown in FIG. 42, a front part of a rolling friction telescopic arm 3 is provided with a material raking and loading part 90. The material raking and loading part 90 further includes a rotating raking and loading machine 91. The rolling friction telescopic arm 3 includes a rotating rolling friction telescopic arm 92. A rear end of the rotating rolling friction telescopic arm 92 is provided with a rotating telescopic arm structure 94, and the rotating telescopic arm structure 94 drives the rotating rolling friction telescopic arm 92 to rotate left and right.

The material raking and loading part 90 also includes a telescopic raking and loading machine.

The rolling friction telescopic arm 3 also includes a fixed rolling friction telescopic arm.

Others are the same as Embodiment 1.

### Embodiment 14

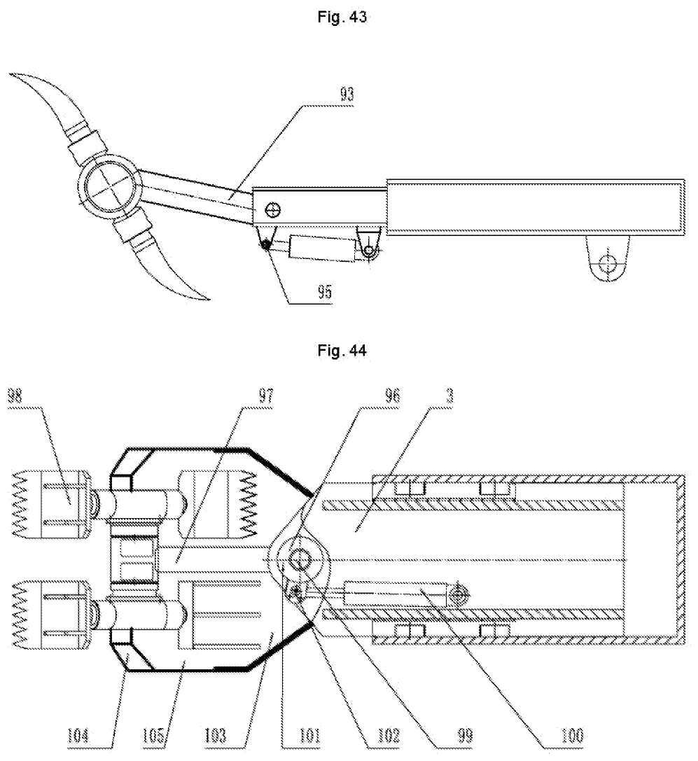

As shown in FIG. 43, a rolling friction telescopic arm 3 includes a hinged shaft rolling friction telescopic arm 93. A rear end of the rotating rolling friction telescopic arm 93 is provided with a rotating telescopic arm structure 95, the telescopic arm hinged shaft 95 supports the hinged shaft rolling friction telescopic arm 93 to swing up and down, and the hinged shaft rolling friction telescopic arm 93 is driven by the lifting power to swing up and down.

The hinged shaft rolling friction telescopic arm 93 may also swing upwards when a material raking and loading part 90 ascends with materials and rakes the materials upwards, and swing downwards when the material raking and loading part 90 descends with the materials and rakes the materials downwards. The weight of the hinged shaft rolling friction telescopic arm 93 also is the material raking gravity.

Others are the same as Embodiment 1.

### Embodiment 15

As shown in FIG. 44, a front part of a rolling friction telescopic arm 3 is provided with a support rotating swing arm structure 96, a rotating swing arm 97, and a rotating raking and loading part 98. The rotating raking and loading part 98 is arranged at a front end of the rotating swing arm 97. The support rotating swing arm structure 96 includes a support rotating arm swing shaft 99 and a rotating swing arm driving piece 100. The rotating swing arm 97 includes a rotating swing arm sleeve 101 and a rotating arm connecting drive device 102. The support rotating arm swing shaft 99 is supported by the rolling friction telescopic arm 3, and the support rotating arm swing shaft 99 penetrates through the rotating swing arm sleeve 101. The rotating arm connecting drive device 102 is arranged on a left side and a right side of the rotating swing arm sleeve 101. One end of the rotating swing arm driving piece 100 is fixed to the rolling friction telescopic arm 3, while the other end thereof is hinged with the rotating arm connecting drive device 102. The rotating swing arm driving piece 100 drives the rotating arm connecting drive device 102, the rotating arm connecting drive device 102 drives the rotating swing arm sleeve 101 to rotate, and the rotating swing arm 97 swings left and right to drive the rotating raking and loading part 98 to swing left and right and rake the materials. Lower parts of the rolling friction telescopic arm 3 and the rotating swing arm 97 are provided with a material receiving, transporting and discharging part 103. The material receiving, transporting and discharging part 103 includes a material receiving, transporting and discharging shovel plate 104. The material receiving, transporting and discharging shovel plate 104 includes a polygonal material receiving, transporting and discharging shovel plate 105. The length of the rotating swing arm 97 and the shape of the rotating raking and loading part 98 are arranged according to the height, width and shape of the material receiving, transporting and discharging part 103, so that the rotating radius of the rotating raking and loading part 98 is matched with the structure of the material receiving, transporting and discharging shovel plate 104 to rake the materials at the periphery of the material receiving, transporting and discharging shovel plate 104 into the material receiving, transporting and discharging part 103.

The support rotating arm swing shaft 99 also is supported by a sliding friction telescopic arm.

The rotating arm connecting drive device 102 also is arranged on the left side or the right side of the rotating swing arm sleeve 101.

One end of the rotating swing arm driving piece 100 also is fixed to the sliding friction telescopic arm.

The material receiving, transporting and discharging shovel plate 104 also includes a square material receiving, transporting and discharging shovel plate or a fan-shaped material receiving, transporting and discharging shovel plate.

Others are the same as Embodiment 1.

### Embodiment 16

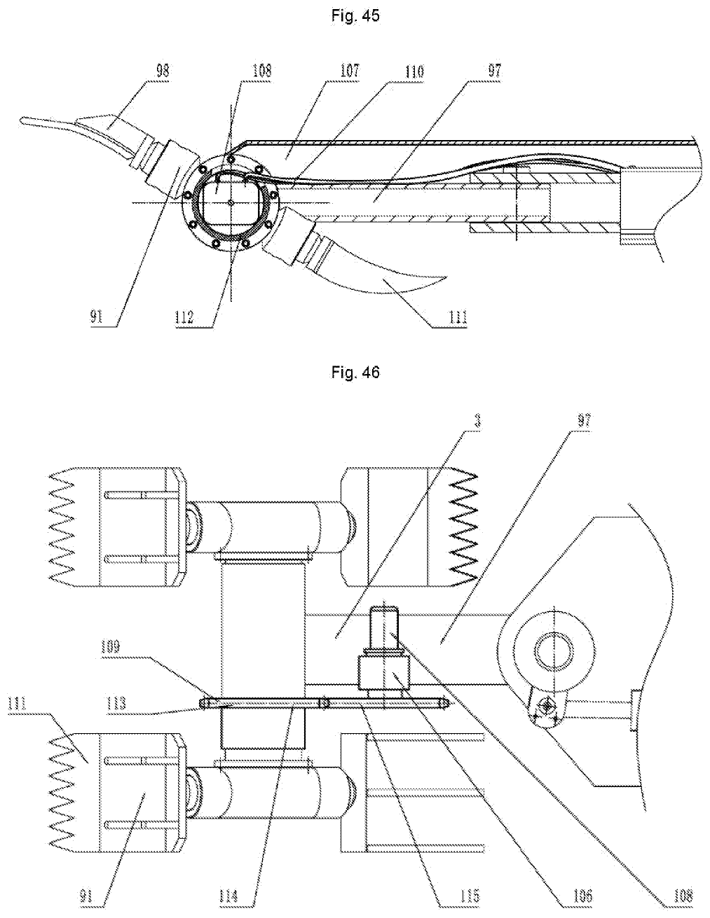

As shown in FIG. 45, a rotating swing arm 97 includes a transmission channel 107. The transmission channel 107 is arranged at an upper part of the rotating swing arm 97. A rotating raking and loading part 98 includes a raking and loading head power piece 108. When the raking and loading head power piece 108 is used, the raking and loading head power piece 108 includes a transmission hose 110. A rotating raking and loading machine 91 is provided with a rotating material raking head 111 and a fixed raking and loading head power piece structure 112. The transmission hose 110 passes through the transmission channel 107. The raking and loading head power piece 108 is arranged on the fixed raking and loading head power piece structure 112, the rotating material raking head 111 is arranged on one side or both sides of the raking and loading head power piece 108, and the raking and loading head power piece 108 rotates to drive the rotating material raking head 111 to rotate and rake and load the material continuously.

The transmission channel 107 also is arranged in the middle of the rotating swing arm 97.

The rotating raking and loading part 98 also includes the raking and loading head power piece 108 and a raking and loading head transmission piece 109.

The raking and loading head power piece 108 also includes a transmission cable.

The transmission cable may also pass through the transmission channel 107 and be connected to the raking and loading head transmission piece 109 or the transmission cable also is arranged at the upper part of the rotating swing arm 97 and connected to the raking and loading head transmission piece 109.

The rotating material raking head 111 also is arranged at one side of the raking and loading head power piece 108.

Others are the same as Embodiment 1.

### Embodiment 17

As shown in FIG. 46, a rotating swing arm 97 also includes a transmission power piece 106. When the transmission power piece 106 is used, a rotating raking and loading machine 91 includes a raking and loading head transmission piece 109. The raking and loading head transmission piece 109 includes a gear transmission piece 113. The gear transmission piece 113 includes a raking and loading head gear transmission piece 114 and a swing arm gear transmission piece 115. The swing arm gear transmission piece 115 is arranged on the rotating swing arm 97, the swing arm gear transmission piece 115 drives the raking and loading head gear transmission piece 114, the raking and loading head gear transmission piece 114 drives a rotating material raking head 111, the swing arm gear transmission piece 115 drives the raking and loading head gear transmission piece 114, and the raking and loading head gear transmission piece 114 drives the rotating raking and loading machine 91, so that the materials are continuously raked and loaded in a rolling manner.

The raking and loading head transmission piece 109 also includes a chain gear transmission piece.

The swing arm gear transmission piece 115 also is arranged on a rolling friction telescopic arm 3.

Others are the same as Embodiment 1.

### Embodiment 18

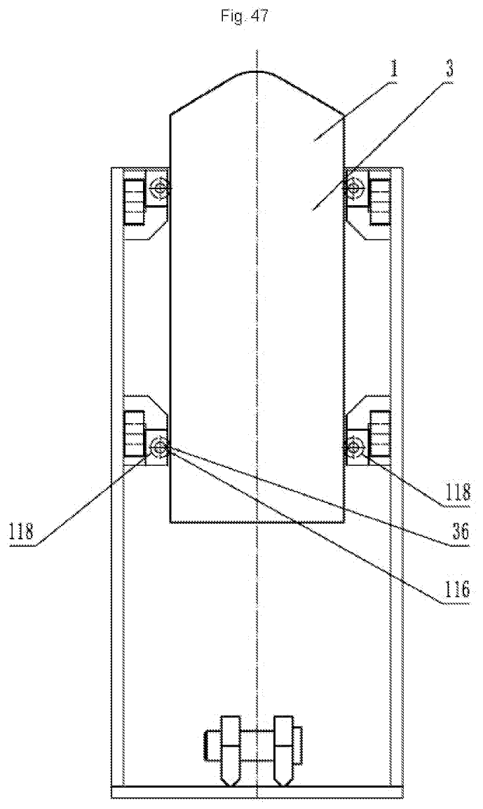

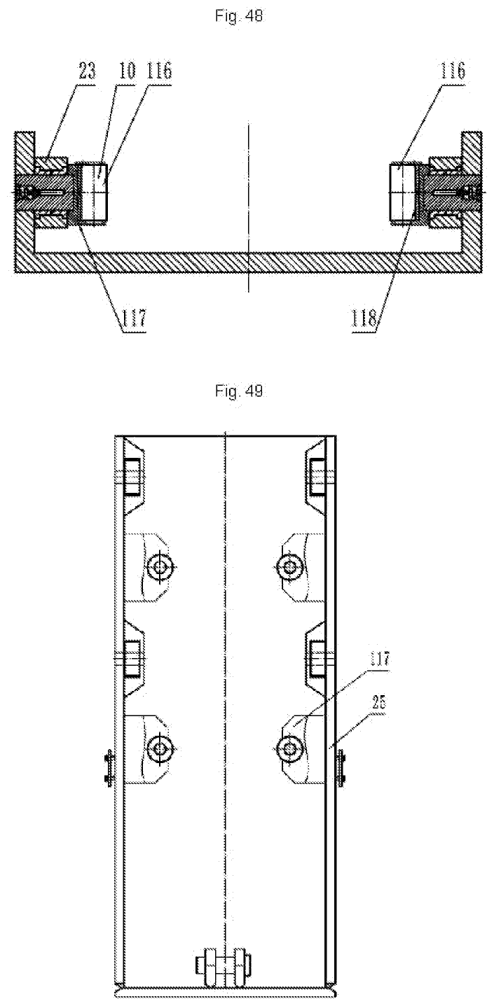

As shown in FIG. 47 to FIG. 49, a left/right-righting telescopic arm guide wheel 10 includes a left/right-righting telescopic arm guide roller 116. When a left/right support up/down guide wheel piece 23 and the left/right-righting telescopic arm guide roller 116 are used, a support left/right-righting roller bracket 117 is arranged on the left/right support up/down guide wheel piece 23. The left/right-righting telescopic arm guide roller 116 is arranged on the support left/right-righting roller bracket 117. The support left/right-righting roller bracket 117 includes a roller arc groove 118. The left/right-righting telescopic arm guide roller 116 is arranged in the roller arc groove 118, so that part of a roller body of the left/right-righting telescopic arm guide roller 116 towards a direction of an attaching left/right-righting face 36 protrudes from a notch of the roller arc groove 118, the protruding part is attached to the attaching left/right-righting face 36, and the left/right-righting telescopic arm guide roller 116 rights the reciprocating stretching and retraction of a rolling friction telescopic arm 3, thereby reducing the left-right thickness of a low-thickness rolling guide telescopic rocker arm 1.

The support left/right-righting roller bracket 117 also is arranged on a telescopic arm bracket plate 25.

Others are the same as Embodiment 1.

### Embodiment 19

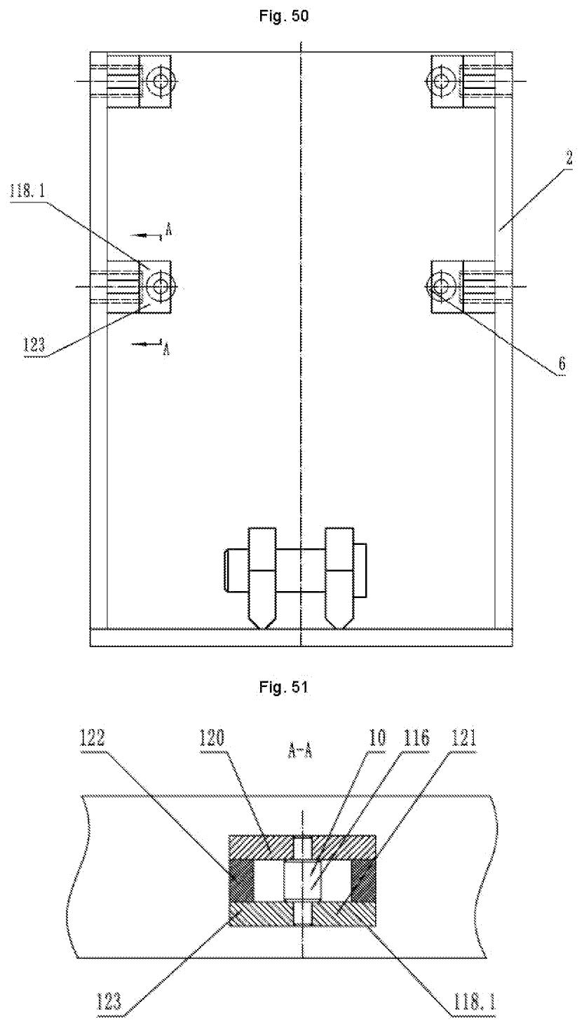

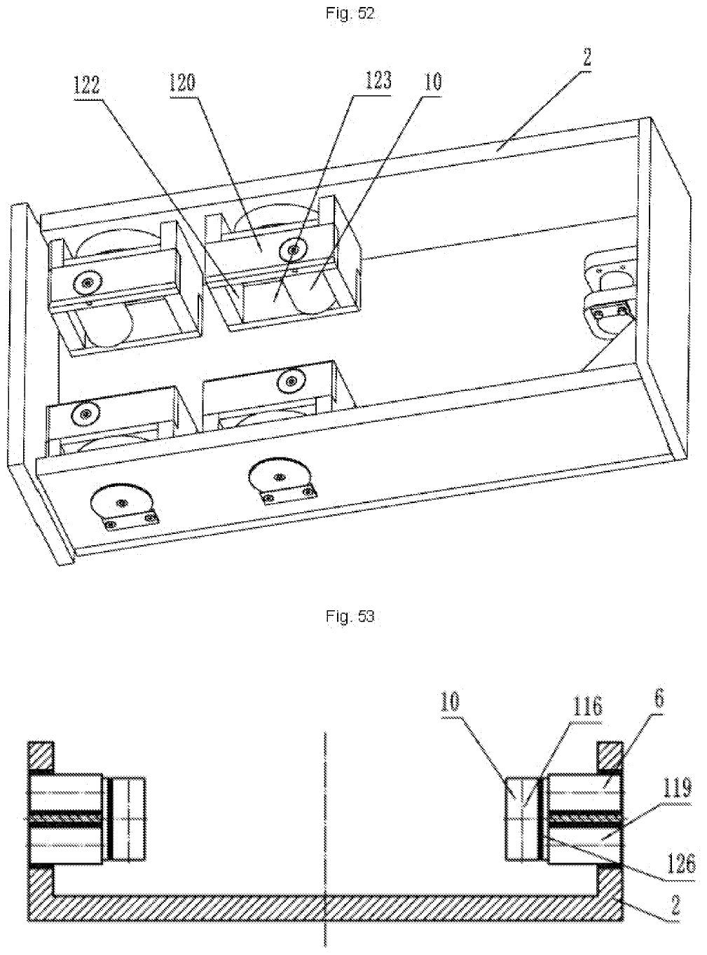

As shown in FIG. 50 to FIG. 52, a telescopic arm bracket 2 further includes a holding telescopic arm guide wheel groove frame 118.1. An up/down support telescopic arm guide wheel 6 includes an up/down support telescopic arm guide roller 119. A left/right-righting telescopic arm guide wheel 10 includes a left/right-righting telescopic arm guide roller 116. When the holding telescopic arm guide wheel groove frame 118.1 is used, the holding telescopic arm guide wheel groove frame 118.1 includes an upper support plate of the guide wheel groove frame 120, a lower support plate of the guide wheel groove frame 121, and an upper and lower support plate connecting piece 122. The upper and lower support plate connecting piece 122 is connected to the upper support plate of the guide wheel groove frame 120 and the lower support plate of the guide wheel groove frame 121, so as to form a support guide wheel frame structure 123. The up/down support telescopic arm guide wheel 6 and the left/right-righting telescopic arm guide wheel 10 are tightly combined in the support guide wheel frame structure 123.

The telescopic arm bracket 2 also includes a support telescopic arm guide wheel plate, the up/down support telescopic arm guide wheel 6 also includes an up/down support telescopic arm guide shaft wheel, and the left/right-righting telescopic arm guide wheel 10 also includes a left/right-righting telescopic arm guide shaft wheel.

Others are the same as Embodiment 1.

### Embodiment 20

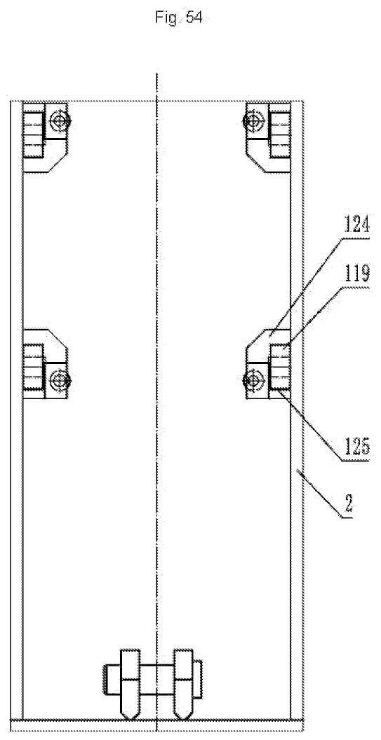

As shown in FIG. 53 to FIG. 54, a telescopic arm bracket 2 further includes a holding telescopic arm guide wheel groove block 124. When the holding telescopic arm guide wheel groove block 124 is used, the holding telescopic arm guide wheel groove block 124 includes a holding up/down guide wheel arc groove 125 and a support left-right guide wheel arc groove 126. An up/down support telescopic arm guide roller 119 is arranged in the holding up/down guide wheel arc groove 125 and a left/right-righting telescopic arm guide roller 116 is arranged in the support left-right guide wheel arc groove 126.

Others are the same as Embodiment 1.

What is claimed is:

1. A low-thickness rolling guide telescopic rocker arm, comprising a telescopic arm bracket, a rolling friction telescopic arm, an up/down-rolling support telescopic arm guide mechanism, and a left/right-righting telescopic arm guide mechanism, wherein the up/down-rolling support telescopic arm guide mechanism comprises an up/down support telescopic arm guide wheel or an up/down support telescopic arm guide piece; the up/down support telescopic arm guide wheel comprises an up/down support guide axle and an up/down support sleeve wheel; the up/down support guide axle and the up/down support sleeve wheel are separately connected or integrated; the left/right-righting telescopic arm guide mechanism comprises a left/right-righting telescopic arm guide wheel or a left/right-righting telescopic arm guide piece; the up/down support telescopic arm guide wheel is arranged on the telescopic arm bracket or the rolling friction telescopic arm; the rolling friction telescopic arm comprises a hollow I-shaped buckle wheel telescopic arm or a square buckle groove roller telescopic arm; the hollow I-shaped buckle wheel telescopic arm comprises a buckling guide wheel groove; the buckling guide wheel groove comprises a left buckling guide wheel groove and/or a right buckling guide wheel groove; the left buckling guide wheel groove comprises an upper face of a left buckling support wheel, a lower face of the left buckling support wheel, and a left attaching left/right-righting face; the up/down support telescopic arm guide wheel rolls against the upper face of the left buckling support wheel or the lower face of the left buckling support wheel; the up/down support telescopic arm guide wheel is matched with the upper face of the left buckling support wheel and the lower face of the left buckling support wheel to guide the rolling friction telescopic arm, so as to prevent the rolling friction telescopic arm during rolling friction stretching and retraction; the right buckling guide wheel groove comprises an upper face of a right buckling support wheel, a lower face of the right buckling support wheel, and a right attaching left/right-righting face; the telescopic arm bracket comprises a left/right support up/down guide wheel piece or an up/down support telescopic arm piece; the telescopic arm bracket further comprises a telescopic arm bracket plate; the left/right support up/down guide wheel piece comprises a left support up/down guide wheel piece and/or a right support up/down guide wheel piece; the left support up/down guide wheel piece and/or the right support up/down guide wheel piece are/is arranged on the telescopic arm bracket plate; when the left/right support up/down guide wheel piece and the left/right-righting telescopic arm guide wheel are used, a support up/down guide axle or a support up/down guide wheel bracket is arranged on the left/right support up/down guide wheel piece, the up/down support telescopic arm guide wheel is arranged on the support up/down guide axle or the support up/down guide wheel bracket, a telescopic arm bracket support left/right-righting wheel bracket is arranged on the left/right support up/down guide wheel piece or an up/down guide wheel bracket support left/right-righting wheel bracket is arranged on the support up/down guide wheel bracket, and the left/right-righting telescopic arm guide wheel is arranged on the telescopic arm bracket support left/right-righting wheel bracket or the up/down guide wheel bracket support left/right-righting wheel bracket; the left buckling guide wheel groove and the right buckling guide wheel groove are arranged on both sides of the rolling friction telescopic arm; a front left up/down support telescopic arm guide wheel, a rear left up/down support telescopic arm guide wheel, a front right up/down support telescopic arm guide wheel, and a rear right up/down support telescopic arm guide wheel are arranged on the telescopic arm bracket; the front left up/down support telescopic arm guide wheel and the rear left up/down support telescopic arm guide wheel are arranged in the left buckling guide wheel groove and between the upper face of the left buckling support wheel and the lower face of the left buckling support wheel; the front right up/down support telescopic arm guide wheel and the rear right up/down support telescopic arm guide wheel are arranged in the right buckling guide wheel groove and between the upper face of the right buckling support wheel and the lower face of the right buckling support wheel; the left attaching left/right-righting face and the right attaching left/right-righting face form an attaching left/right-righting face; the left/right-righting telescopic arm guide wheel is arranged in the buckling guide wheel groove and a surface thereof is attached to the attaching left/right-righting face; the front left up/down support telescopic arm guide wheel and the rear left up/down support telescopic arm guide wheel support and guide the rolling friction telescopic arm through the upper face of the left buckling support wheel and the lower face of the left buckling support wheel, and the front right up/down support telescopic arm guide wheel and the rear right up/down support telescopic arm guide wheel support and guide the rolling friction telescopic arm through the upper face of the right buckling support wheel and the lower face of the right buckling support wheel, so as to prevent the rolling friction telescopic arm from shaking up and down; the telescopic arm bracket is provided with a left front left/right-righting telescopic arm guide wheel, a left rear left/right-righting telescopic arm guide wheel, a right front left/right-righting telescopic arm guide wheel, and a right rear left/right-righting telescopic arm guide wheel; and the left front left/right-righting telescopic arm guide wheel, the left rear left/right-righting telescopic arm guide wheel, the right front left/right-righting telescopic arm guide wheel, and the right rear left/right-righting telescopic arm guide wheel guide the rolling friction telescopic arm through the attaching left/right-righting face, so as to prevent the rolling friction telescopic arm from shaking left and right.

2. The low-thickness rolling guide telescopic rocker arm according to claim 1, wherein the rolling friction telescopic arm comprises the hollow I-shaped buckle wheel telescopic arm or the square buckle groove roller telescopic arm; when the hollow I-shaped buckle wheel telescopic arm is used, the hollow I-shaped buckle wheel telescopic arm comprises a hollow I-shaped frame; the left buckling guide wheel groove and the right buckling guide wheel groove are arranged on both sides of the hollow I-shaped buckle wheel telescopic arm; the hollow I-shaped frame comprises an I-shaped hollow structure; the rolling friction telescopic arm comprises a telescopic oil cylinder; a front end of the telescopic oil cylinder is connected to a front part of the I-shaped hollow structure, and a rear end of the telescopic oil cylinder is connected to the telescopic arm bracket; the telescopic oil cylinder stretches and retracts to drive the rolling friction telescopic arm to stretch and retract; or when the square buckle groove roller telescopic arm is used, the square buckle groove roller telescopic arm comprises a square telescopic frame and a flank roller mechanism, wherein the flank roller mechanism is arranged on both sides of the square telescopic frame, and comprises an up/down support telescopic arm roller and a left/right-righting telescopic arm roller or comprises the up/down support telescopic arm roller and a left/right-righting telescopic arm guide plate; the up/down support telescopic arm roller and the left/right-righting telescopic arm roller form an up/down left/right guide wheel set; the up/down left/right guide wheel set comprises a left front up/down left/right guide wheel set, a left rear up/down left/right guide wheel set, a right front up/down left/right guide wheel set, and a right rear up/down left/right guide wheel set; the left front up/down left/right guide wheel set and the left rear up/down left/right guide wheel set are sequentially arranged on a left side of the square telescopic frame, and the right front up/down left/right guide wheel set and the right rear up/down left/right guide wheel set are sequentially arranged on a right side of the square telescopic frame; the telescopic arm bracket comprises a bracket left buckle wheel groove and a bracket right buckle wheel groove; the bracket left buckle wheel groove comprises an upper plate of the bracket left buckle wheel groove and a lower plate of the bracket left buckle wheel groove; the bracket right buckle wheel groove comprises an upper plate of the bracket right buckle wheel groove and a lower plate of the bracket right buckle wheel groove; the upper plate of the bracket left buckle wheel groove and the upper plate of the bracket right buckle wheel groove are separated or integrated, and the lower plate of the bracket left buckle wheel groove and the lower plate of the bracket right buckle wheel groove are separated or integrated; the left front up/down left/right guide wheel set and the left rear up/down left/right guide wheel set are arranged in the bracket left buckle wheel groove, and the right front up/down left/right guide wheel set and the right rear up/down left/right guide wheel set are arranged in the bracket right buckle wheel groove; the left front up/down left/right guide wheel set, the left rear up/down left/right guide wheel set, the right front up/down left/right guide wheel set, and the right rear up/down left/right guide wheel set support the square telescopic frame; one end of the telescopic oil cylinder is connected to a front part of the square telescopic frame, while the other end thereof is connected to the telescopic arm bracket; and the telescopic oil cylinder stretches and retracts to drive the square buckle groove roller telescopic arm to stretch and retract.

3. The low-thickness rolling guide telescopic rocker arm according to claim 1, wherein the telescopic arm bracket comprises a wheel groove frame; the wheel groove frame comprises a left wheel groove frame and/or a right wheel groove frame; the telescopic arm bracket further comprises a left support wheel groove frame piece and/or a right support wheel groove frame piece; the left wheel groove frame is arranged on the left support wheel groove frame piece, and the right wheel groove frame is arranged on the right support wheel groove frame piece; the telescopic arm bracket comprises a holding wheel groove frame plate; the wheel groove frame is arranged on the side of the holding wheel groove frame plate; a gap for placing the left buckling guide wheel groove and the right buckling guide wheel groove is arranged between the wheel groove frame and the holding wheel groove frame plate; a front support guide wheel groove frame hole and/or a rear support guide wheel groove frame hole are/is arranged on the left wheel groove frame; a front left support guide axle hole and/or a rear left support guide axle hole are/is correspondingly arranged in the left support wheel groove frame piece; the up/down support telescopic arm guide wheel is arranged in the front support guide wheel groove frame hole, and supported by the front left support guide axle hole and/or the rear left support guide axle hole; the surface of the up/down support telescopic arm guide wheel is higher than the surface of the wheel groove frame; and the upper and lower surfaces of the up/down support telescopic arm guide wheel are respectively matched with the upper face of the left buckling support wheel and the lower face of the left buckling support wheel in parallel, the lower face of the left buckling support wheel and the lower face of the right buckling support wheel support the rolling friction telescopic arm, and the upper face of the left buckling support wheel and the upper face of the right buckling support wheel limit the rolling friction telescopic arm to tilt up.

4. The low-thickness rolling guide telescopic rocker arm according to claim 1, wherein the left/right-righting telescopic arm guide wheel comprises a left/right-righting telescopic arm shaft and a left/right-righting telescopic arm wheel, wherein the left/right-righting telescopic arm shaft penetrates through the left/right-righting telescopic arm wheel to guide the rolling friction of the rolling friction telescopic arm left and right; a support left-right guide axle piece is arranged on an end face of a support up/down guide wheel bracket towards the attaching left/right-righting face of the rolling friction telescopic arm; the support left-right guide axle piece comprises an upper support left-right guide axle piece and a lower support left-right guide axle piece, which support the left/right-righting telescopic arm shaft; the left/right-righting telescopic arm shaft penetrates through the left/right-righting telescopic arm wheel to guide the rolling friction of the telescopic arm left and right; or when the left/right-righting telescopic arm shaft and the left/right-righting telescopic arm wheel are integrated, the left/right-righting telescopic arm shaft and the left/right-righting telescopic arm wheel form a left/right-righting telescopic arm shaft wheel; the upper support left-right guide axle piece and the lower support left-right guide axle piece support the left/right-righting telescopic arm shaft wheel; the attaching left/right-righting face protrudes from the bottom of the left buckling guide wheel groove and the right buckling guide wheel groove to the side of the left/right-righting telescopic arm shaft wheel; the protruding length of the attaching left/right-righting face makes the left/right-righting telescopic arm shaft wheel abut against the attaching left/right-righting face; the left/right-righting telescopic arm shaft wheel rotates to guide the rolling friction of the rolling friction telescopic arm left and right; the left/right-righting telescopic arm guide piece comprises a flat plate left/right-righting telescopic arm piece or an arc plate left/right-righting telescopic arm piece or a ball plate left/right-righting telescopic arm piece or a hole plate left/right-righting telescopic arm piece or a groove plate left/right-righting telescopic arm piece or a roller plate left/right-righting telescopic arm piece; when the roller plate left/right-righting telescopic arm piece is used, the roller plate left/right-righting telescopic arm piece comprises an embedded roller hole plate and a roller; the width of a roller hole exposed on the embedded roller hole plate is less than the diameter of the roller; and the embedded roller hole plate is fixed to the wheel groove frame, the roller is arranged on the embedded roller hole plate, a cylinder part thereof exposes the embedded roller hole plate, and a roller surface is attached to the left attaching left/right-righting face and/or the right attaching left/right-righting face, so as to right the rolling friction telescopic arm left and right.

5. The low-thickness rolling guide telescopic rocker arm according to claim 1, wherein a front end of the rolling friction telescopic arm is provided with an excavation head or a material raking head or an impact head; when the rolling friction telescopic arm stretches and retracts forwards, a wheel face of the front left up/down support telescopic arm guide wheel is attached to the upper face of the left buckling support wheel, a wheel face of the rear left up/down support telescopic arm guide wheel is attached to the lower face of the left buckling support wheel, a wheel face of the front right up/down support telescopic arm guide wheel is attached to the upper face of the right buckling support wheel, and a wheel face of the right rear up/down support telescopic arm guide wheel is attached to the lower face of the right buckling support wheel; the left/right-righting telescopic arm guide wheel comprises the left front left/right-righting telescopic arm guide wheel, the right front left/right-righting telescopic arm guide wheel, the left rear left/right-righting telescopic arm guide wheel, and the right rear left/right-righting telescopic arm guide wheel; the wheel faces of the left front left/right-righting telescopic arm guide wheel and the left rear left/right-righting telescopic arm guide wheel are attached to the left attaching left/right-righting face, and the wheel faces of the right front left/right-righting telescopic arm guide wheel and the right rear left/right-righting telescopic arm guide wheel are attached to the right attaching left/right-righting face; the left front left/right-righting telescopic arm guide wheel, the right front left/right-righting telescopic arm guide wheel, the left rear left/right-righting telescopic arm guide wheel, and the right rear left/right-righting telescopic arm guide wheel are attached to the left/right-righting faces to prevent the rolling friction telescopic arm from shaking left and right; and a distance between the upper face of the left buckling support wheel and the lower face of the left buckling support wheel is greater than or equal to the diameter of the up/down support telescopic arm guide wheel, and the spacing range is no more than 10 mm, so that the excavation head or the material raking head or the impact head is stably supported.

6. The low-thickness rolling guide telescopic rocker arm according to claim 1, wherein a front part of the rolling friction telescopic arm is provided with a material raking and loading part; the material raking and loading part further comprises a rotating raking and loading machine or a telescopic raking and loading machine; the rolling friction telescopic arm comprises a rotating rolling friction telescopic arm or a fixed rolling friction telescopic arm or a hinged shaft rolling friction telescopic arm; a rear end of the rotating rolling friction telescopic arm is provided with a rotating telescopic arm structure, and the rotating telescopic arm structure drives the rotating rolling friction telescopic arm to rotate left and right; a rear end of the hinged shaft rolling friction telescopic arm is provided with a telescopic arm hinged shaft, the telescopic arm hinged shaft supports the hinged shaft rolling friction telescopic arm to swing up and down, the hinged shaft rolling friction telescopic arm is driven by a lifting power to swing up and down, or the hinged shaft rolling friction telescopic arm swings upwards when the material raking and loading part ascends with materials and rakes the materials upwards, and swings downwards when the material raking and loading part descends with the materials and rakes the materials downwards; and the weight of the hinged shaft rolling friction telescopic arm is the material raking gravity.

7. The low-thickness rolling guide telescopic rocker arm according to claim 1, wherein a front part of the rolling friction telescopic arm is provided with a support rotating swing arm structure, a rotating swing arm, and a rotating raking and loading part, wherein the rotating raking and loading part is arranged at a front end of the rotating swing arm; the support rotating swing arm structure comprises a support rotating arm swing shaft and a rotating swing arm driving piece; the rotating swing arm comprises a rotating swing arm sleeve and a rotating arm connecting drive device; the support rotating arm swing shaft is supported by the rolling friction telescopic arm or a sliding friction telescopic arm, and the support rotating arm swing shaft penetrates through the rotating swing arm sleeve; the rotating arm connecting drive device is arranged on a left side and/or a right side of the rotating swing arm sleeve; one end of the rotating swing arm driving piece is fixed to the rolling friction telescopic arm or the sliding friction telescopic arm, while the other end thereof is hinged with the rotating arm connecting drive device; the rotating swing arm driving piece drives the rotating arm connecting drive device, the rotating arm connecting drive device drives the rotating swing arm sleeve to rotate, and the rotating swing arm swings left and right to drive the rotating raking and loading part to swing left and right and rake the materials; lower parts of the rolling friction telescopic arm and the rotating swing arm are provided with a material receiving, transporting and discharging part; the material receiving, transporting and discharging part comprises a material receiving, transporting and discharging shovel plate; the material receiving, transporting and discharging shovel plate comprises a fan-shaped material receiving, transporting and discharging shovel plate or a square material receiving, transporting and discharging shovel plate or a polygonal material receiving, transporting and discharging shovel plate; the length of the rotating swing arm and the shape of the rotating raking and loading part are arranged according to the height, width and shape of the material receiving, transporting and discharging part, so that the rotating radius of the rotating raking and loading part is matched with the structure of the material receiving, transporting and discharging shovel plate to rake the materials at the periphery of the material receiving, transporting and discharging shovel plate into the material receiving, transporting and discharging part.

8. The low-thickness rolling guide telescopic rocker arm according to claim 1, wherein a rotating swing arm comprises a transmission power piece or a transmission channel; the transmission channel is arranged in the middle of the rotating swing arm or an upper part of the rotating swing arm; the rotating raking and loading part comprises a raking and loading head power piece and/or a raking and loading head transmission piece; when the raking and loading head power piece is used, the raking and loading head power piece comprises a transmission hose or a transmission cable; a rotating raking and loading machine is provided with a rotating material raking head and a fixed raking and loading head power piece structure; the transmission hose or the transmission cable passes through the transmission channel and is connected to the raking and loading head transmission piece or the transmission hose or the transmission cable is arranged at the upper part of the rotating swing arm and connected to the raking and loading head transmission piece; the raking and loading head power piece is arranged on the fixed raking and loading head power piece structure, the rotating material raking head is arranged on one side or both sides of the raking and loading head power piece, and the raking and loading head power piece rotates to drive the rotating material raking head to rotate and rake and load the material continuously; when the transmission power piece is used, the rotating raking and loading machine comprises the raking and loading head transmission piece; the raking and loading head transmission piece comprises a gear transmission piece or a chain gear transmission piece; the gear transmission piece comprises a raking and loading head gear transmission piece and a swing arm gear transmission piece; the swing arm gear transmission piece is arranged on the rotating swing arm or the rolling friction telescopic arm, the swing arm gear transmission piece drives the raking and loading head gear transmission piece, the raking and loading head gear transmission piece drives the rotating material raking head, the swing arm gear transmission piece drives the raking and loading head gear transmission piece, and the raking and loading head gear transmission piece drives the rotating raking and loading machine, so that the materials are continuously raked and loaded in a rolling manner.

9. The low-thickness rolling guide telescopic rocker arm according to claim 1, wherein the left/right-righting telescopic arm guide wheel comprises a left/right-righting telescopic arm guide roller; when the left/right support up/down guide wheel piece and the left/right-righting telescopic arm guide roller are used, a support left/right-righting roller bracket is arranged on the left/right support up/down guide wheel piece or the telescopic arm bracket plate; the left/right-righting telescopic arm guide roller is arranged on the support left/right-righting roller bracket; the support left/right-righting roller bracket comprises a roller arc groove; the left/right-righting telescopic arm guide roller is arranged in the roller arc groove, so that part of roller body of the left/right-righting telescopic arm guide roller towards a direction of the attaching left/right-righting face protrudes from a notch of the roller arc groove, the protruding part is attached to the attaching left/right-righting face, and the left/right-righting telescopic arm guide roller rights the reciprocating stretching and retraction of the rolling friction telescopic arm, thereby reducing the left-right thickness of the low-thickness rolling guide telescopic rocker arm.

10. The low-thickness rolling guide telescopic rocker arm according to claim 1, wherein the telescopic arm bracket further comprises a support telescopic arm guide wheel plate or a holding telescopic arm guide wheel groove frame or a holding telescopic arm guide wheel groove block; the up/down support telescopic arm guide wheel comprises an up/down support telescopic arm guide roller or an up/down support telescopic arm guide wheel; the left/right-righting telescopic arm guide wheel comprises a left/right-righting telescopic arm guide roller or a left/right-righting telescopic arm guide shaft wheel; when the holding telescopic arm guide wheel groove frame is used, the holding telescopic arm guide wheel groove frame comprises an upper support plate of the guide wheel groove frame, a lower support plate of the guide wheel groove frame, and an upper and lower support plate connecting piece; the upper and lower support plate connecting piece is connected to the upper support plate of the guide wheel groove frame and the lower support plate of the guide wheel groove frame, so as to form a support guide wheel frame structure; the up/down support telescopic arm guide wheel and the left/right-righting telescopic arm guide wheel are tightly combined in the support guide wheel frame structure, or when the holding telescopic arm guide wheel groove block is used, the holding telescopic arm guide wheel groove block comprises a holding up/down guide wheel arc groove and/or a support left-right guide wheel arc groove; the up/down support telescopic arm guide roller is arranged in the holding up/down guide wheel arc groove and/or the left/right-righting telescopic arm guide roller is arranged in the support left-right guide wheel arc groove.
